(19) United States
(12) Patent Application Publication
(10) Pub. No.: US 2011/0199461 A1
(43) Pub. Date: Aug. 18, 2011

(54) FLOW LINE PRODUCTION SYSTEM, FLOW LINE PRODUCTION DEVICE, AND THREE-DIMENSIONAL FLOW LINE DISPLAY DEVICE

(75) Inventors: Kazuyuki Horio, Tokyo (JP); Mikio Morioka, Kanagawa (JP); Masataka Sugiura, Tokyo (JP); Go Nakano, Tokyo (JP); Toshiki Kanehara, Tokyo (JP)

(73) Assignee: PANASONIC CORPORATION, Osaka (JP)

(21) Appl. No.: 13/123,788

(22) PCT Filed: Sep. 1, 2009
(86) PCT No.: PCT/JP2009/004293

§ 371 Date: Apr. 12, 2011

(30) Foreign Application Priority Data
Oct. 17, 2008 (JP) 2008-268687
Jan. 29, 2009 (JP) 2009-018740

(51) Int. Cl. G06K 9/64; H04N 13/02

(52) U.S. Cl. 348/46; 382/103; 348/E13.075

(57) ABSTRACT

A motion locus creation system which is capable of displaying the trajectory of movement of an object to be tracked in an understandable way even if using no 3D model information. A camera unit forms a detection flag indicating whether or not the object to be tracked has been able to be detected from a captured image. A motion locus-type selection section determines the display type of a motion locus according to the detection flag. A motion locus creation section produces a motion locus according to coordinate data acquired by a tag reader section and a motion locus-type instruction signal selected by the motion locus-type selection section.

### TECHNICAL FIELD

The present invention relates to a motion locus creation system, motion locus creation apparatus, and motion locus creation method that create a motion locus that is a path of movement of an object, and a three-dimensional motion locus display apparatus.

### BACKGROUND ART

Heretofore, many technologies have been proposed that display a motion locus (path of movement) of an object (person, article, or the like) positioned using a wireless tag, surveillance camera, or the like. Displaying such a motion locus makes it possible to monitor a suspicious person, look for abnormal behavior by a person and warn that person, improve work efficiency through worker behavior analysis, implement layout design based on consumer behavior analysis, and so forth.

Motion locus creation apparatuses of this kind have heretofore been disclosed in Patent Literature 1 and Patent Literature 2.

Patent Literature 1 discloses a technology whereby a path of a moving object in an image is found by means of image processing, and this path is displayed superimposed on a moving image.

Patent Literature 2 discloses a technology whereby positioning data for a moving object is obtained using a wireless ID tag attached to the moving object, and this path is displayed superimposed on a moving image.

### CITATION LIST

### Patent Literature

PTL 1
Japanese Patent Application Laid-Open No. 2006-350618
PTL 2
Japanese Patent Application Laid-Open No. 2005-71252
PTL 3
Japanese Patent Application Laid-Open No.1992-71083

### Non-Patent Literature

NPL 1
Shin Joho Kyoiku Library M-10, Three-Dimensional CG Basics and Applications, CHIBA Norishige, SAKAI Koji, Saiensu-Sha, ISBN4-7819-0862-8 PP. 54-56
NPL 2
IIO Jun et al., “A User Interface Using 3D Information of User's Head Position,” Eighth Moving Image Sensing Symposium (SSII2002), pp. 573-576, July 2002

### SUMMARY OF INVENTION

### Technical Problem

A deficiency of the technology disclosed in Patent Literature 1 is that a moving object that enters a concealed position as viewed from a camera cannot be tracked, and therefore an accurate motion locus cannot be created while a moving object is in a concealed position. Also, since tracking is no longer possible after a moving object enters a concealed position, it is difficult to determine the sameness of a moving object that enters a concealed position and a moving object that emerges from a concealed position.

Also, a deficiency of the technology disclosed in Patent Literature 2 is that, although tracking is possible even if a moving object enters a concealed position as viewed from a camera, it is not possible to determine whether or not a moving object is in a concealed position, and therefore even if a moving object enters a concealed position a motion locus continues to be drawn unchanged, and it is extremely difficult for a user to ascertain a path of movement.

One example of a technology that detects whether or not a moving object has entered a concealed position is the Z buffer method described in Non-Patent Literature 1. The Z buffer method uses a 3D model of imaged space. Here, a combination of technology of Patent Literature 2 and the Z buffer method can be conceived of. That is to say, performing shade line processing using path-of-movement information obtained from a wireless ID tag and 3D model data can be conceived of.

However, in order to implement the Z buffer method, it is necessary to obtain 3D model information of an imaged space (depth information from a camera) beforehand, and this is a complicated procedure. More particularly, this is impractical when a 3D model changes over time.

It is an object of the present invention to provide a motion locus creation system, motion locus creation apparatus, and three-dimensional motion locus display apparatus that are capable of displaying a path of movement of an object to be tracked in an understandable way without using 3D model information.

### Solution to Problem

One aspect of a motion locus creation system of the present invention is provided with: an imaging section that obtains a captured image of an area including an object to be tracked; a positioning section that positions the object to be tracked and outputs positioning data of the object to be tracked; a motion locus type selection section that selects a display type of a motion locus corresponding to each point in time according to whether or not the object to be tracked is shown in the captured image of each point in time; a motion locus creation section that forms motion locus data based on the positioning data and a motion locus display type selected by the motion locus type selection section; and a display section that displays an image based on the captured image and a motion locus based on the motion locus data in an overlapping manner.

One aspect of a motion locus creation apparatus of the present invention is provided with: a motion locus type selection section that selects a display type of a motion locus corresponding to each point in time according to whether or not an object to be tracked is shown in a captured image of each point in time; and a motion locus creation section that forms motion locus data based on positioning data of the object to be tracked and a motion locus display type selected by the motion locus type selection section.

One aspect of a three-dimensional motion locus display apparatus of the present invention is provided with: an imaging section that obtains a captured image including an object; a position detection section that obtains positioning data of the object having three-dimensional information composed of a horizontal-direction component, a depth-direction component, and a height-direction component; a motion locus generation section that is a section that generates a motion locus that is a path of movement of the object using the positioning data, and that generates a rounded motion locus for which a predetermined coordinate component relating to the positioning data is fixed at a constant value; and a display section that performs combined display of the captured image and the rounded motion locus on a two-dimensional display.

### Advantageous Effects of Invention

The present invention enables a motion locus creation system, motion locus creation apparatus, and three-dimensional motion locus display apparatus to be implemented that are capable of displaying a path of movement of an object to be tracked in an understandable way without using 3D model information.

### BRIEF DESCRIPTION OF DRAWINGS

FIG. 1 is a block diagram showing the configuration of a motion locus creation system according to Embodiment 1 of the present invention;

FIG. 2 is a flowchart showing the operation of a camera section;

FIG. 3 is a flowchart showing the operation of a motion locus type selection section;

FIG. 4 is a flowchart showing the operation of a motion locus creation section;

FIG. 5 is a drawing showing the nature of motion loci created and displayed by a motion locus creation system of this embodiment, in which FIG. 5A is a drawing showing a motion locus when a person walks in front of an object, and FIG. 5B is a drawing showing a motion locus when a person walks behind (and is concealed by) an object;

FIG. 6 is a block diagram showing the configuration of a motion locus creation system according to Embodiment 2 of the present invention;

FIG. 7 is a flowchart showing the operation of a motion locus type selection section;

FIG. 8 is a drawing showing a sample display image in which a captured image and a motion locus are displayed combined;

FIG. 9 is a drawing showing a sample display image in which a captured image and a motion locus are displayed combined;

FIG. 10 is a drawing showing a sample display image of Embodiment 3;

FIG. 11 is a drawing showing a sample display image of Embodiment 3;

FIG. 12 is a drawing showing a sample display image of Embodiment 3;

FIG. 13A is a drawing showing a sample display image of Embodiment 3, and FIG. 13B is a drawing showing a mouse wheel;

FIG. 14 is a block diagram showing the configuration of a three-dimensional motion locus display apparatus of Embodiment 3;

FIG. 15 is a drawing showing the nature of movement vectors;

FIG. 16 is a drawing showing the relationship between a line-of-sight vector and a movement vector;

FIG. 17A and FIG. 17B are drawing showing cases in which a line-of-sight vector and a movement vector are close to parallel, and FIG. 17C is a drawing showing a case in which a line-of-sight vector and a movement vector are close to perpendicular;

FIG. 18 is a block diagram showing the configuration of a three-dimensional motion locus display apparatus of Embodiment 4;

FIG. 19 is a drawing showing a sample display image of Embodiment 5;

FIG. 20 is a block diagram showing the configuration of a three-dimensional motion locus display apparatus of Embodiment 6;

FIG. 21 is a drawing showing a sample display image of Embodiment 6;

FIG. 22 is a block diagram showing the configuration of a three-dimensional motion locus display apparatus of Embodiment 6;

FIG. 23 is a drawing showing a sample display image of Embodiment 7;

FIG. 24 is a drawing showing a sample display image of Embodiment 7;

FIG. 25 is a drawing showing a sample display image of Embodiment 7;

FIG. 26 is a drawing showing a sample display image of Embodiment 8;

FIG. 27 is a block diagram showing the configuration of a three-dimensional motion locus display apparatus of Embodiment 8; and

FIG. 28 is a drawing showing a sample display image of Embodiment 8.

### DESCRIPTION OF EMBODIMENTS

Now, embodiments of the present invention will be described in detail with reference to the accompanying drawings. In the following embodiments, cases are described in which an object to be tracked is a person, but an object to be tracked is not limited to a person, and may also be a vehicle or the like, for example.

### Embodiment 1

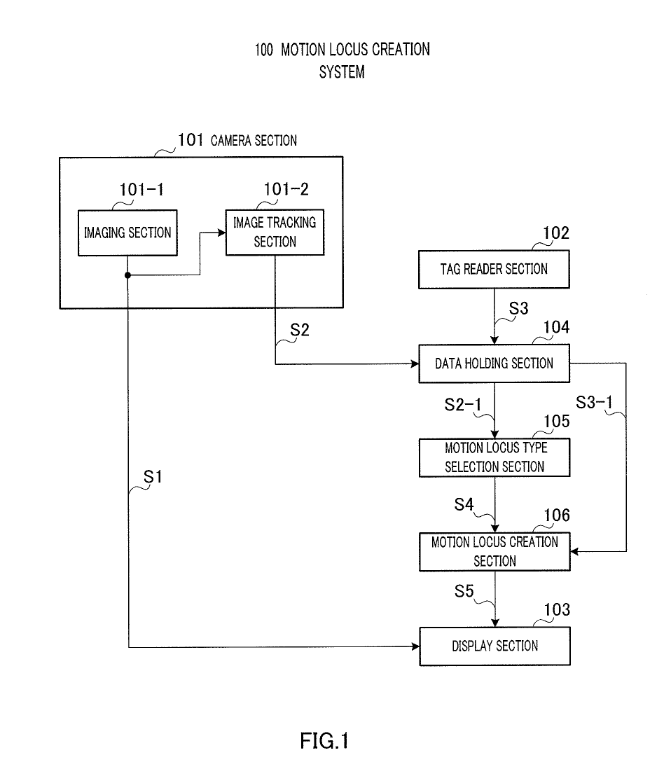

FIG. 1 shows the configuration of a motion locus creation system according to Embodiment 1 of the present invention. Motion locus creation system 100 has camera section 101, tag reader section 102, display section 103, data holding section 104, motion locus type selection section 105, and motion locus creation section 106.

Camera section 101 has imaging section 101-1 and image tracking section 101-2. Imaging section 101-1 captures an image of an area including an object to be tracked, and sends captured image S1 to display section 103 and image tracking section 101-2. Image tracking section 101-2 uses captured image S1 obtained at each point in time by imaging section 101-1 to track a person who is an object to be tracked. In this embodiment, for an image of each point in time, image tracking section 101-2 forms detection flag S2 indicating whether or not a person is being detected, and sends this detection flag S2 to data holding section 104.

Tag reader section 102 has a radio receiving section that receives a radio signal from a wireless tag, a positioning section that finds wireless tag position coordinates based on a received radio signal, and a coordinate conversion section that converts found position coordinates to XY coordinates on a display image. Tag reader section 102 sends converted wireless tag coordinate data S3 to data holding section 104.

An existing technology such as a three-point measurement method based on the field intensity of a radio signal received from a wireless tag, an arrival time/arrival direction estimation method, or the like, can be used by the positioning section of tag reader section 102 as a method of finding position coordinates. It is also possible to use a configuration in which a wireless tag itself incorporates a GPS or suchlike positioning function, and transmit its own positioning result to the radio receiving section of input interface section 120 as a radio signal. In this case, tag reader section 102 need not have a positioning section. Also, the above coordinate conversion section may be provided in data holding section 104 instead of being provided in tag reader section 102.

Data holding section 104 outputs detection flag S2-1 and coordinate data S3-1 of each point in time for an object to be tracked, together with timing. Detection flag S2-1 is input to motion locus type selection section 105, and coordinate data S3-1 is input to motion locus creation section 106.

Motion locus type selection section 105 determines whether or not an object to be tracked is in a concealed position at each point in time based on detection flag S2-1. Specifically, if detection flag S2-1 is ON (if an object to be tracked is being detected by camera section 101—that is, if an object to be tracked is shown in a captured image), it is determined that the object to be tracked is not in a concealed position. On the other hand, if detection flag S2-1 is OFF (if an object to be tracked is not being detected by camera section 101—that is, if an object to be tracked is not shown in a captured image), it is determined that the object to be tracked is in a concealed position.

Motion locus type selection section 105 forms motion locus type command signal S4 based on the determination result, and sends this to motion locus creation section 106. In this embodiment, motion locus type command signal S4 is formed that gives a “solid line” command if an object to be tracked is shown, and gives a “dotted line” command if an object to be tracked is not shown.

Motion locus creation section 106 forms motion locus data S5 by connecting coordinate data S3-1 of each point in time. At this time, motion locus creation section 106 forms motion locus data S5 by selecting a motion locus type for each line segment based on motion locus type command signal S4. Motion locus data S5 is sent to display section 103.

Display section 103 performs overlapping display of an image based on captured image S1 input from camera section 101 and a motion locus based on motion locus data S5 input from motion locus creation section 106. By this means, a motion locus that is a path of an object to be tracked is displayed superimposed on an image captured by camera section 101.

The operation of this embodiment will now be described.

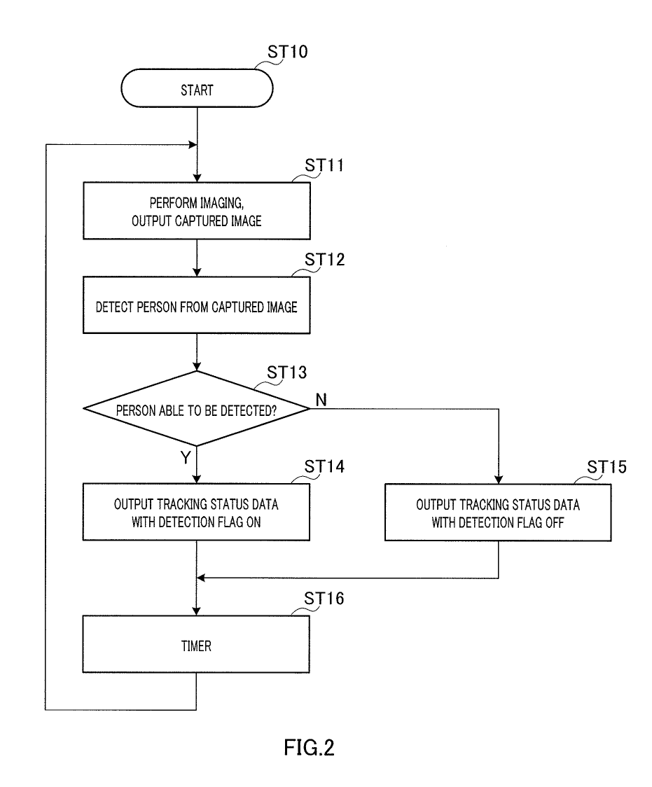

FIG. 2 shows the operation of camera section 101. Upon starting processing in step ST10, in step ST11 camera section 101 performs imaging by means of imaging section 101-1, and outputs captured image S1 to display section 103 and image tracking section 101-2. In step ST12, image tracking section 101-2 detects a person who is an object to be tracked from captured image S1 using a method such as pattern matching.

In step ST13, image tracking section 101-2 determines whether or not a person has been able to be detected. If a person has been able to be detected, the processing flow proceeds to step ST14, and tracking status data with detection flag S2 ON is output. On the other hand, if a person has not been able to be detected, the processing flow proceeds to step ST15, and tracking status data with detection flag S2 OFF is output.

Next, camera section 101 waits for a predetermined time by performing timer processing in step ST16, and then returns to step ST11. The wait time in the timer processing in step ST16 can be set according to the speed of movement of an object to be tracked, for instance. For example, the imaging interval can be shortened by setting a shorter wait time for a faster speed of movement of an object to be tracked.

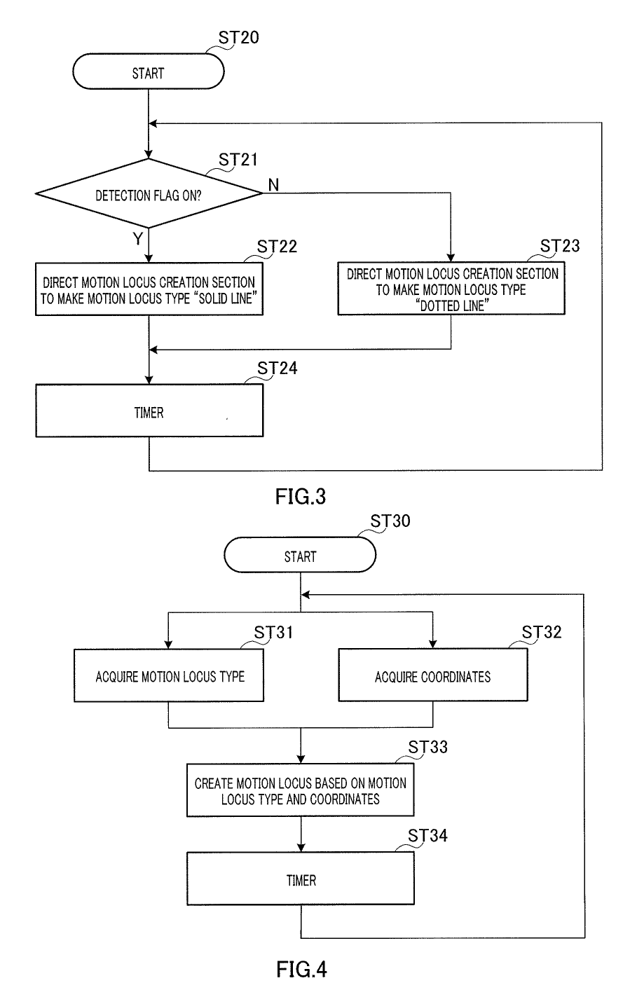

FIG. 3 shows the operation of motion locus type selection section 105. Upon starting processing in step ST20, motion locus type selection section 105 determines whether or not the detection flag is ON in step ST21. If the detection flag is determined to be ON, motion locus type selection section 105 proceeds to step ST22, and directs motion locus creation section 106 to make the motion locus type “solid line.” On the other hand, if the detection flag is determined to be OFF, motion locus type selection section 105 proceeds to step ST23, and directs motion locus creation section 106 to make the motion locus type “dotted line.” Motion locus type selection section 105 then waits for a predetermined time by performing timer processing in step ST24, and then returns to step ST21. This wait time should be set to match the imaging interval of camera section 101.

FIG. 4 shows the operation of motion locus creation section 106. Upon starting processing in step ST30, motion locus creation section 106 acquires a motion locus type by inputting motion locus type command signal S4 from motion locus type selection section 105 in step ST31, and also acquires coordinate data S3-1 for an object to be tracked by inputting coordinate data S3-1 from data holding section 104 in step ST32. Then, in step ST33, motion locus creation section 106 creates a motion locus by connecting the end point of a motion locus created up to the previous time to the coordinate point acquired this time with a motion locus of the type acquired this time. Next, motion locus creation section 106 waits for a predetermined time by performing timer processing in step ST34, and then returns to step ST31 and step ST32. This wait time should be set to match the imaging interval of camera section 101.

The wait time set in step ST34 may be matched to a wireless tag positioning time interval (an interval at which coordinate data S3 of each point in time is output from tag reader section 102), or may be made a fixed time set beforehand. Normally, the imaging interval of camera section 101 is shorter than a wireless tag positioning interval, and therefore it is desirable for the wait time to be set to a fixed time greater than or equal to a wireless tag positioning time interval.

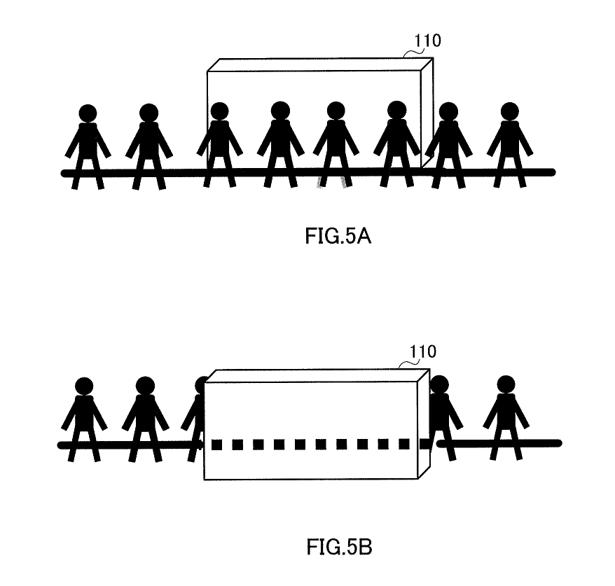

FIG. 5 shows the nature of motion loci created and displayed by motion locus creation system 100 of this embodiment. As shown in FIG. 5A, when a person walks in front of object 110, a motion locus at the position of object 110 is made a “solid line.” On the other hand, as shown in FIG. 5B, when a person walks behind (and is concealed by) object 110, a motion locus at the position of object 110 is made a “dotted line.” By this means, a user can easily ascertain from the motion locus whether a person has moved in front of object 110 or has moved behind (and is concealed by) object 110.

As explained above, according to this embodiment, camera section 101 forms detection flag (tracking status data) S2 indicating whether or not an object to be tracked has been able to be detected from captured image S1, motion locus type selection section 105 decides a motion locus display type based on detection flag S2, and motion locus creation section 106 creates a motion locus based on coordinate data S3 obtained by tag reader section 102 and motion locus type command signal S4 decided by motion locus type selection section 105. By this means, a motion locus can be displayed that clearly indicates whether an object to be tracked has moved in front of object 110 or has moved behind object 110, and an easily understandable path of movement can be displayed, without using 3D model information.

In this embodiment, a case has been described in which a path of movement is formed by means of only coordinate data obtained by tag reader section 102, but a path of movement may also be found using coordinate data obtained by image tracking section 101-2 in a complementary manner.

### Embodiment 2

In this embodiment, a preferred aspect is presented for a case in which the basic components of the configuration described in Embodiment 1 are maintained and there are additionally a plurality of objects to be tracked.

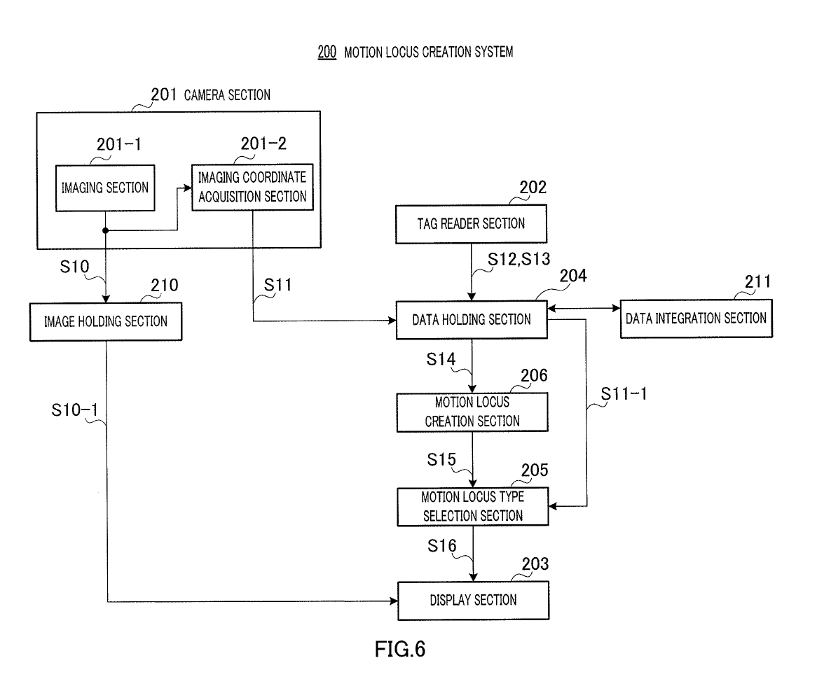

FIG. 6 shows the configuration of motion locus creation system 200 according to this embodiment.

Camera section 201 has imaging section 201-1 and imaging coordinate acquisition section 201-2. Imaging section 201-1 captures an image of an area including an object to be tracked, and sends captured image S10 to image holding section 210 and imaging coordinate acquisition section 201-2. Image holding section 210 temporarily holds captured image S10, and outputs captured image S10-1 whose timing has been adjusted to display section 203.

Imaging coordinate acquisition section 201-2 acquires the coordinates of a person who is an object to be tracked using captured image S10 obtained at each point in time by imaging section 201-1. Imaging coordinate acquisition section 201-2 sends coordinate data of a person detected in an image of each point in time to data holding section 204 as imaging coordinate data S11. If there are a plurality of detected persons, imaging coordinate acquisition section 201-2 tracks a plurality of persons, and outputs imaging coordinate data S11 for a plurality of persons.

Tag reader section 202 has a radio receiving section that receives information by radio from a wireless tag. Tag reader section 202 has a positioning function that finds wireless tag position coordinates based on a received radio signal, and a tag ID receiving function. In the same way as described in Embodiment 1, a configuration may also be used in which a positioning function is incorporated in a wireless tag itself, and tag reader section 202 receives a positioning result. Tag reader section 202 sends a wireless tag's tag coordinate data S12 and tag ID data S13 as a pair to data holding section 204.

By this means, imaging coordinate data S11, tag ID data S13, and tag coordinate data S12 corresponding to a tag ID, are stored in data holding section 204. If there are a plurality of persons who are objects to be tracked, a plurality of imaging coordinate data S11, a plurality of tag ID data S13, and a plurality of tag coordinate data S12 corresponding to the respective tag IDs, are stored at each point in time.

Data integration section 211 reads data stored in data holding section 204, and performs person integration and coordinate integration. Person integration means integrating corresponding persons' imaging coordinates and tag coordinates from among imaging coordinates and tag coordinates of a plurality of persons. At this time, data integration section 211 can integrate corresponding persons' imaging coordinates and tag coordinates by, for example, identifying a person corresponding to each set of imaging coordinates using a person image recognition method, and linking together an identified person and a tag ID. Also, items with mutually close coordinates between imaging coordinates and tag coordinates may be integrated as imaging coordinates and tag coordinates of a corresponding person.

Data integration section 211 integrates imaging coordinates and tag coordinates as XY plane coordinates by further normalizing imaging coordinates and tag coordinates. Here, normalization includes processing for interpolation using tag coordinates if imaging coordinates are missing, using both imaging coordinates and tag coordinates of a corresponding person. Integrated and normalized coordinate data S14 of each person is sent to motion locus creation section 206 via data holding section 204.

Motion locus creation section 206 creates motion locus vector data S15 indicating tracking results up to the present time by sequentially connecting a vector from coordinates of a previous point in time to coordinates of the next point in time, and sends this motion locus vector data S15 to motion locus type selection section 205.

Motion locus type selection section 205 has motion locus vector data S15 and imaging coordinate data S11-1 as input. Motion locus type selection section 205 performs motion locus vector division on a fixed section basis, and determines a motion locus type indicated by a motion locus vector for each section according to whether or not there is imaging coordinate data S11-1 corresponding to each section. Motion locus type selection section 205 sends motion locus data S16 including a motion locus vector and section-specific motion locus vector type information to display section 203.

Specifically, if there is imaging coordinate data S11-1 corresponding to a motion locus vector, motion locus type selection section 205 determines that an object to be tracked is present in front of an object, and outputs motion locus data S16 directing that a motion locus indicated by the motion locus vector is to be displayed as a “solid line.” On the other hand, if there is no imaging coordinate data S11-1 corresponding to a motion locus vector, motion locus type selection section 205 determines that an object to be tracked is present behind an object, and outputs motion locus data S16 directing that a motion locus indicated by the motion locus vector is to be displayed as a “dotted line.”

The above-described processing by motion locus creation section 206 and motion locus type selection section 205 is performed for each person who is an object to be tracked.

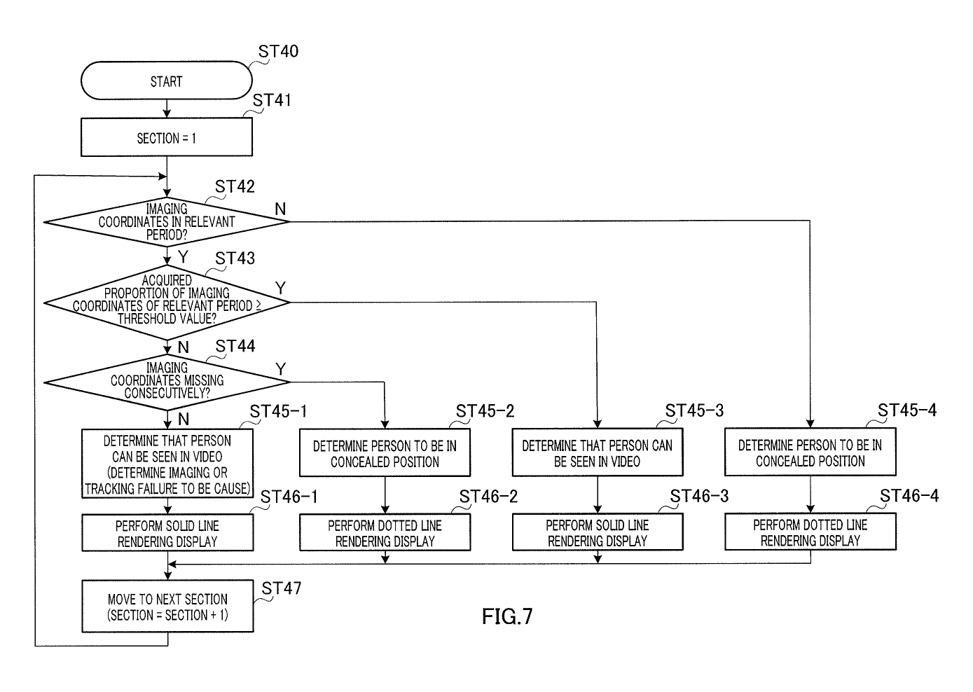

FIG. 7 shows the motion locus type determination operation of motion locus type selection section 205. Upon starting motion locus type determination processing in step ST40, motion locus type selection section 205 initializes a section of a motion locus vector for which determination is to be performed (sets section=1) in step ST41.

In step ST42, it is determined whether or not there are imaging coordinates, using imaging coordinate data S11-1 of a period corresponding to the set motion locus vector section. If there are no imaging coordinates, the processing flow proceeds to step ST45-4, it is determined that a person is in a concealed position, and in step ST46-4 a motion locus indicated by the relevant motion locus vector is displayed as a “dotted line.” On the other hand, if there are imaging coordinates, the processing flow proceeds from step ST42 to step ST43.

In step ST43, it is determined whether or not a proportion for which imaging coordinates have been able to be acquired is greater than or equal to a threshold value, using imaging coordinate data S11-1 of a period corresponding to the set motion locus vector section. If a proportion for which imaging coordinates have been able to be acquired is greater than or equal to the threshold value, the processing flow proceeds to step ST45-3, it is determined that a person can be seen in the video, and in step ST46-3 a motion locus indicated by the relevant motion locus vector is displayed as a “solid line.” On the other hand, if a proportion for which imaging coordinates have been able to be acquired is less than the threshold value, the processing flow proceeds from step ST43 to step ST44.

In step ST44, it is determined whether or not imaging coordinates are missing consecutively, using imaging coordinate data S11-1 of a period corresponding to the set motion locus vector section. Here, “imaging coordinates are missing consecutively” means a case in which captured images in which an object to be tracked is not shown continue for at least threshold value th (where th≧2). If imaging coordinates are missing consecutively, the processing flow proceeds to step ST45-2, it is determined that a person is in a concealed position, and in step ST46-2 a motion locus indicated by the relevant motion locus vector is displayed as a “dotted line.” On the other hand, if imaging coordinates are not missing consecutively, the processing flow proceeds from step ST44 to step ST45-1, it is determined that a person can be seen in the video (it is determined that imaging coordinate data S11-1 has not been obtained due to an imaging failure or a person detection (tracking) failure), and in step ST46-1 a motion locus indicated by the relevant motion locus vector is displayed as a “solid line.”

After the processing in steps ST46-1 through ST46-4, motion locus type selection section 205 proceeds to step ST47, sets the next section as a motion locus vector section for determination (sets section=section+1), and returns to step ST42.

Thus, by determining a motion locus type comprehensively based on the presence or absence of imaging coordinates for each section and the proportion of missing imaging coordinates in steps ST42, ST43, and ST44, motion locus type selection section 205 can avoid erroneously determining that a section for which there has been an imaging coordinate acquisition failure is a “concealed position” section. By this means, accurate motion locus type selection can be performed.

In this embodiment, a case has been described in which a motion locus type is selected by means of three-step processing comprising steps ST42, ST43, and ST44, but a motion locus type may also be selected by means of two-step processing comprising any two of steps ST42, ST43, and ST44, or by means of one-step processing using one of steps ST43 and ST44.

As described above, according to this embodiment, even if there are a plurality of objects to be tracked at the same point in time, the provision of data integration section 211 enables a motion locus to be created for each object to be tracked.

Also, by determining that an object to be tracked is not shown in a captured image only if captured images in which an object to be tracked is not shown continue for at least threshold value th (where th≧2), it is possible to avoid erroneously determining that a section for which there has been an imaging coordinate acquisition failure is a “concealed position” section. Similarly, by determining that an object to be tracked is not shown in a captured image only if the ratio of the number of captured images in which an object to be tracked is not shown, to the total number of a temporally consecutive plurality of captured images, is greater than or equal to a threshold value, it is possible to avoid erroneously determining that a section for which there has been an imaging coordinate acquisition failure is a “concealed position” section.

### Embodiment 3

In this embodiment and following Embodiments 4 through 8, three-dimensional motion locus display apparatuses are presented that show a user a three-dimensional motion locus in an understandable way by improving visibility when a motion locus having three-dimensional information is displayed on a two-dimensional image.

The present inventors considered visibility when a motion locus having three-dimensional information is displayed on a two-dimensional image.

In Patent Literature 1, for example, a technology is disclosed whereby a path of movement of an object detected using image recognition processing is displayed combined with a camera image.

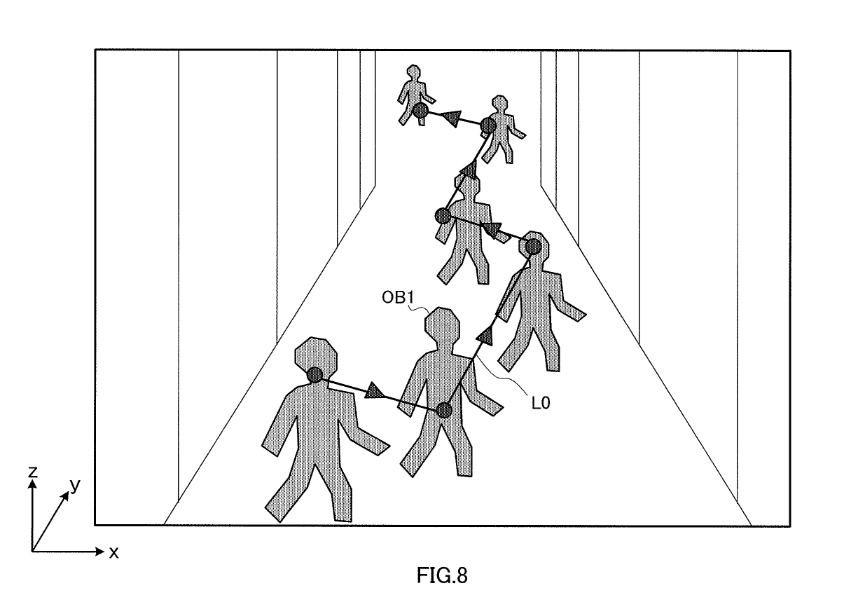

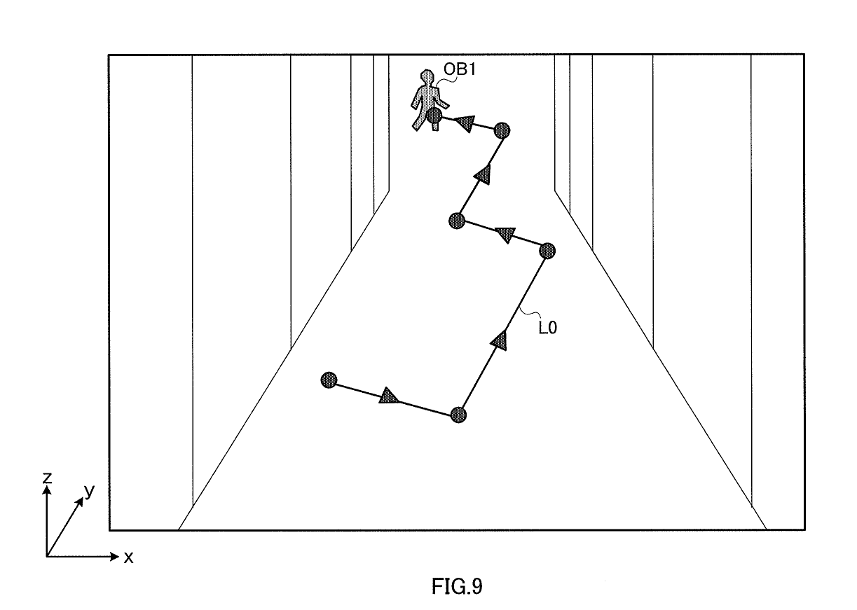

Three-dimensional coordinates of an object are assumed to be represented by the coordinate axes shown in FIG. 8. That is to say, the three-dimensional coordinates of an object are the x-axis (horizontal direction), y-axis (depth direction), and z-axis (height direction) in FIG. 8.

The technology disclosed in Patent Literature 1 displays a two-dimensional path of movement in an object camera image (screen) combined with the camera image, and does not display a three-dimensional path of movement that includes depth-direction movement viewed from a camera. Therefore, if an object is hidden in a concealed position or objects overlap each other, for instance, a path of movement is cut off midway, and a path of movement of an object cannot be adequately ascertained.

On the other hand, Patent Literature 3 discloses a display method devised so that a path of movement of an object can be seen three-dimensionally. Specifically, in Patent Literature 3, depth-direction movement of an object is represented by displaying a trajectory of motion of an object (particle) in ribbon form and performing hidden-surface removal processing.

If a path of movement of an object having three-dimensional information is displayed combined with a camera image, a user can be shown a more detailed path of movement, and therefore implementation of such a display apparatus is desirable.

However, heretofore, the visibility of a display image on a two-dimensional display when displaying a three-dimensional path of movement combined with a camera image has not been sufficiently considered.

The present inventors investigated traditional problems associated with displaying a three-dimensional path of movement combined with a camera image on a two-dimensional display. The results of this investigation are described below using FIG. 8 and FIG. 9.

FIG. 8 is an example in which a camera image is displayed on a two-dimensional display, and motion locus (path of movement) L0 having three-dimensional information for object OB1 is displayed combined with the camera image on a two-dimensional display. Motion locus L0 is formed by connecting historical positioning points of object OB1 indicated by black circles in the drawing. FIG. 8 is an example in which a human object that is object OB1 is displayed together with a motion locus.

In the case of such an example, it is difficult to see from the path of movement display image whether movement of object OB1 is in the depth direction or in the height direction.

That is to say, when only motion locus L0 is displayed, as shown in FIG. 9, a user cannot discern whether displacement of a motion locus in the screen in the vertical direction of the screen is due to a movement of object OB1 in the depth direction or a movement of object OB1 in the height direction, and it is difficult to ascertain the movement of an object from a displayed path of movement.

Furthermore, when a positioning result includes height-direction error (error occurs, for example, according to the attaching position or radio wave environment of a wireless tag in positioning that uses a wireless tag), a user cannot discern whether displacement of a motion locus in the vertical direction of the screen is due to a movement of object OB1 in the height direction, a movement of object OB1 in the depth direction, or height-direction positioning error, and it becomes still more difficult to ascertain the movement of an object from a path of movement.

Incidentally, although the technology disclosed in Patent Literature 3 does not originally presuppose display of a path of movement combined with a camera image, if superimposition of a path of movement on a camera image by means of a ribbon is assumed, the image will be hidden by the ribbon, and there is a possible problem of simultaneous recognition of a camera image and motion locus being impeded.

This embodiment and following Embodiments 4 through 8 are based on the above considerations.

Before describing the configuration of this embodiment, display images created and displayed by a three-dimensional motion locus display apparatus of this embodiment will first be described.

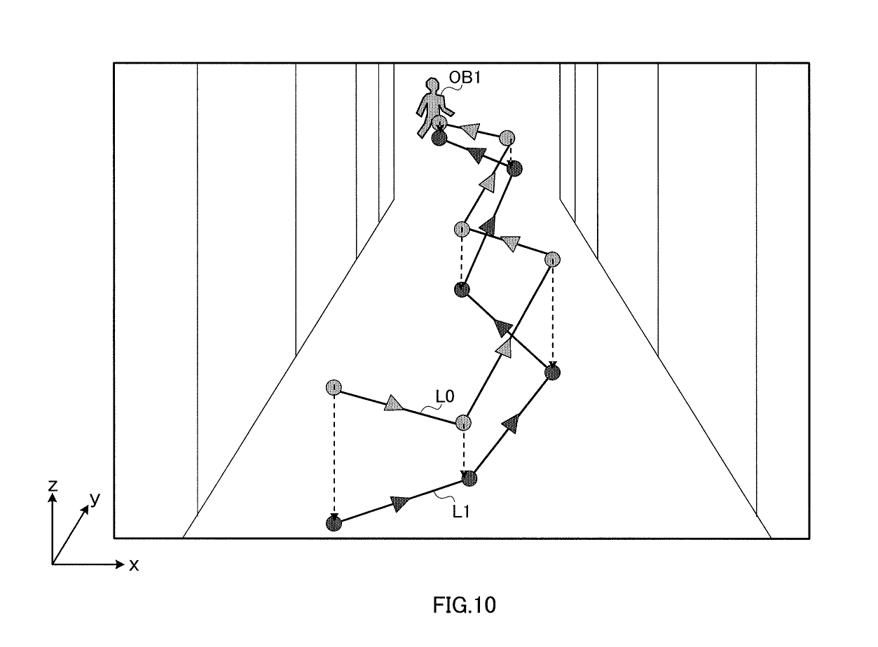

FIG. 10 shows a display image in which rounded motion locus L1 resulting from actual motion locus (hereinafter referred to as original motion locus) L0 based on positioning data being pasted (projected) onto the floor is displayed. Rounded motion locus L1 is formed by fixing a height-direction component (z-direction component) of motion locus L0 to the floor (that is, setting z=0), and then performing coordinate conversion to a camera field-of-view coordinate system. By recognizing that motion locus L1 displayed in this way is fixed to the floor, an observer (user) can identify a movement of object OB1 in the depth direction and a movement of object OB1 in the vertical direction without misperception. Here, a rounded motion locus has been assumed to be a motion locus resulting from projecting an original motion locus onto the floor, but the essential point is that a predetermined coordinate component relating to positioning data be fixed at a constant value so that a rounded motion locus is a motion locus resulting from projecting an original motion locus onto a movement plane of object OB1.

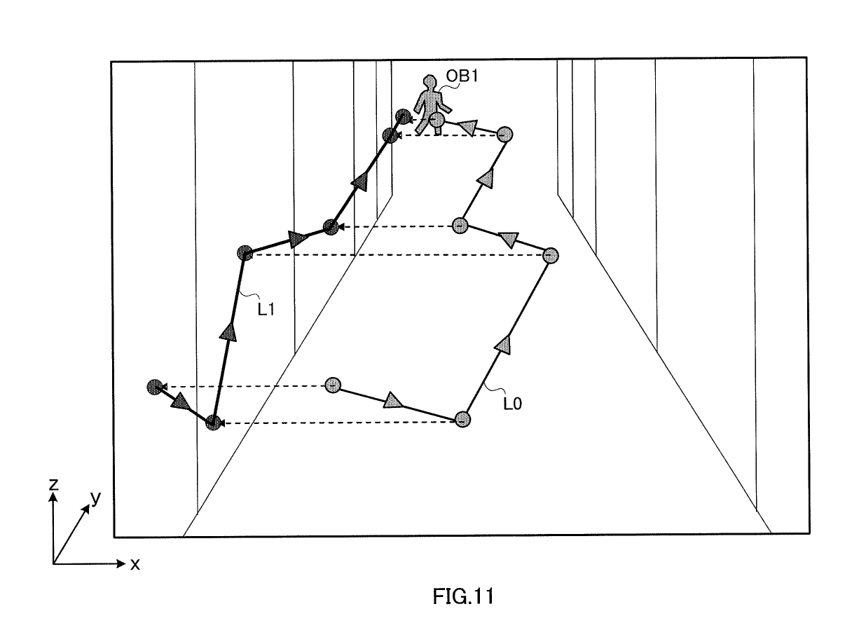

(ii) FIG. 11 shows a display image in which rounded motion locus L1 resulting from original motion locus L0 based on positioning data being pasted (projected) onto a wall is displayed. Rounded motion locus L1 is formed by fixing a horizontal-direction component (x-direction component) of motion locus L0 to a wall (that is, setting x=wall x-coordinate), and then performing coordinate conversion to a field-of-view coordinate system of a camera. By this means, the nature of height-direction (z-direction) and depth-direction (y-direction) movements of object OB1 can be recognized in an image.

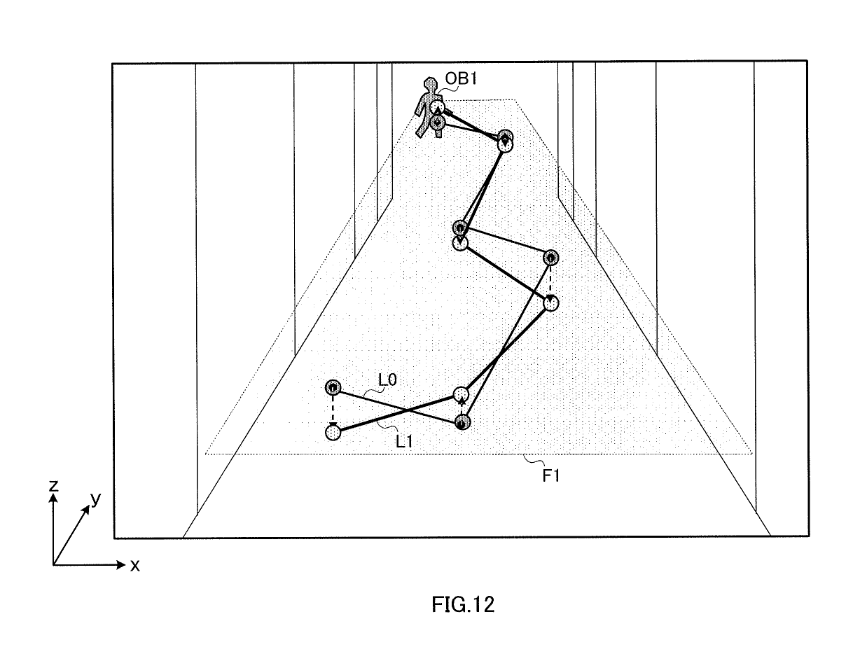

(iii) FIG. 12 shows a display image in which rounded motion locus L1 resulting from original motion locus L0 based on positioning data being pasted (projected) onto plane F1 that is an average value of height components of motion locus L0 in a predetermined period is displayed. Rounded motion locus LI is formed by fixing a height-direction component (z-direction component) of motion locus L0 to plane F1 (that is, setting z=height component average value in predetermined period), and then performing coordinate conversion to a field-of-view coordinate system of a camera. By this means, the nature of a planar movement (movement in the xy plane) of object OB1 can be recognized in an image, and at approximately what height object OB1 is moving can also be recognized to some extent from the height of plane F1.

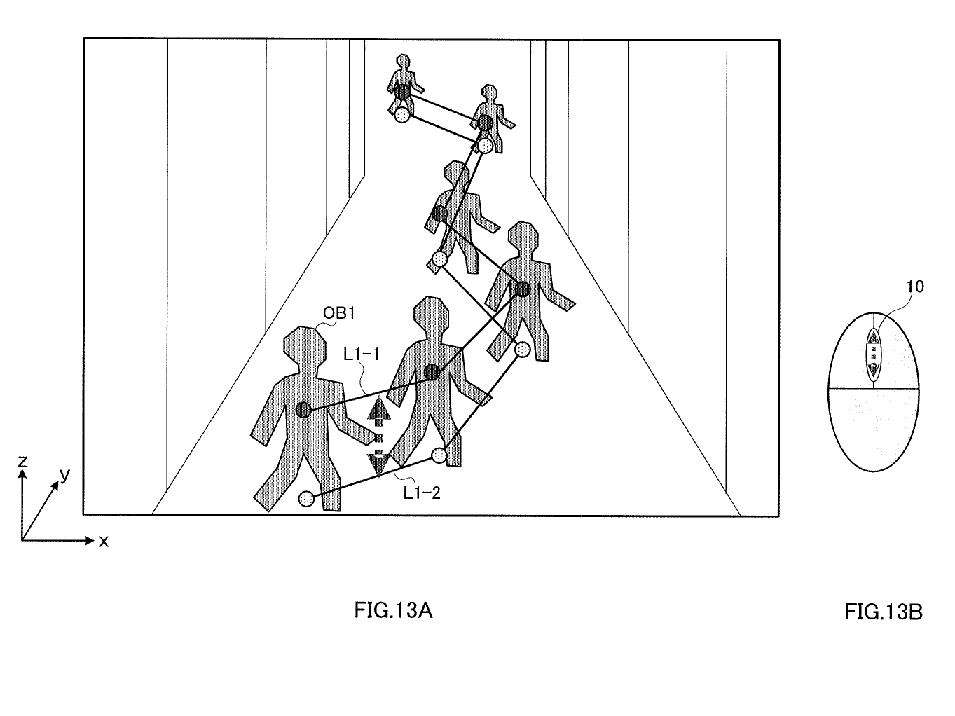

(iv) FIG. 13A shows the nature of an image in which rounded motion loci that move in parallel over time in the height direction are displayed by generating a rounded motion locus resulting from fixing a height-direction component in positioning data at a constant value, generating plurality of rounded motion loci L1-1 and L1-2 that move in parallel over time in the height direction (z-direction) by changing the constant value, and displaying these rounded motion loci L1-1 and L1-2 sequentially. In FIG. 13A, only two rounded motion loci L1-1 and L1-2 are shown in order to simplify the drawing, but a rounded motion locus is also generated between rounded motion loci L1-1 and L1-2 and the rounded motion locus is displayed moved in parallel in the height direction between rounded motion loci L1-1 and L1-2. By this means, a transparent (perspective) transformation type result is obtained in the image simply by changing the height of a rounded motion locus, and the anteroposterior relationship of a motion locus extending in the depth direction (y-direction) can easily be grasped. Parallel movement control can be performed, for example, according to the degree of user operation of mouse wheel 10, as shown in FIG. 13B. Parallel movement control may also be performed according to the degree of user operation of a slider bar or the like, the number of depressions of a predetermined key (arrow key) on a keyboard, and so forth.

(v) In this embodiment, it is proposed, as a preferred example, that threshold value based determination should be performed for an amount of fluctuation per unit time of a horizontal-direction component or height-direction component in positioning data, rounded motion locus L1 should be displayed if the amount of fluctuation is greater than or equal to the threshold value, and original motion locus L0 should be displayed if the amount of fluctuation is less than the threshold value. By this means, it is possible to display rounded motion locus L1 only if visibility actually degrades when original motion locus L0 is displayed.

(vi) In this embodiment, it is proposed, as a preferred example, that rounded motion locus L1, original motion locus L0 on which rounding processing is not performed, and lines connecting corresponding points on rounded motion locus L1 and original motion locus L0 (dotted lines in the drawings) should be displayed simultaneously, as shown in FIG. 10, FIG. 11, and FIG. 12. By this means, it is possible to provide pseudo-presentation of three-dimensional movement directions of object OB1 without obscuring the image. That is to say, when rounded motion locus L1 resulting from fixing a height-direction (z-direction) component at a constant value is displayed as shown in FIG. 10 and FIG. 12, movement of object OB1 in the xy plane can be recognized by means of rounded motion locus L1, and movement of object OB1 in the height direction (z-direction) can be recognized by means of the length of a segment connecting corresponding points on rounded motion locus L1 and original motion locus L0. On the other hand, when rounded motion locus L1 resulting from fixing a horizontal-direction (x-direction) component at a constant value is displayed as shown in FIG. 11, movement of object OB1 in the yz plane can be recognized by means of rounded motion locus L1, and movement of object OB1 in the horizontal direction (x-direction) can be recognized by means of the length of a segment connecting corresponding points on rounded motion locus L1 and original motion locus L0.

The configuration of a three-dimensional motion locus display apparatus that creates and displays an above-described display image will now be described.

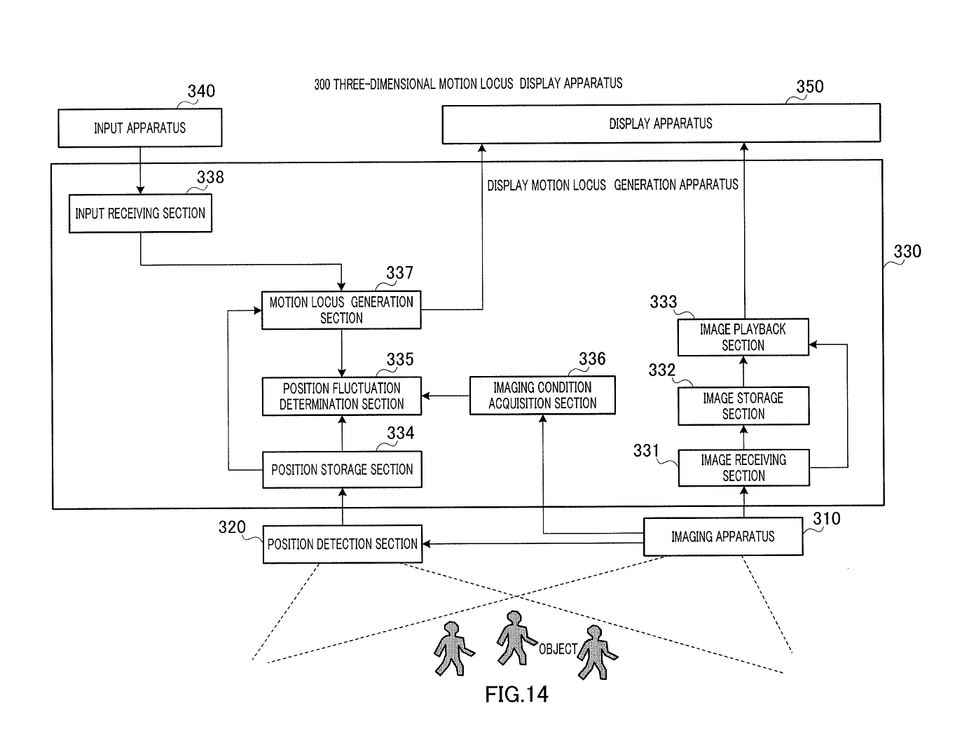

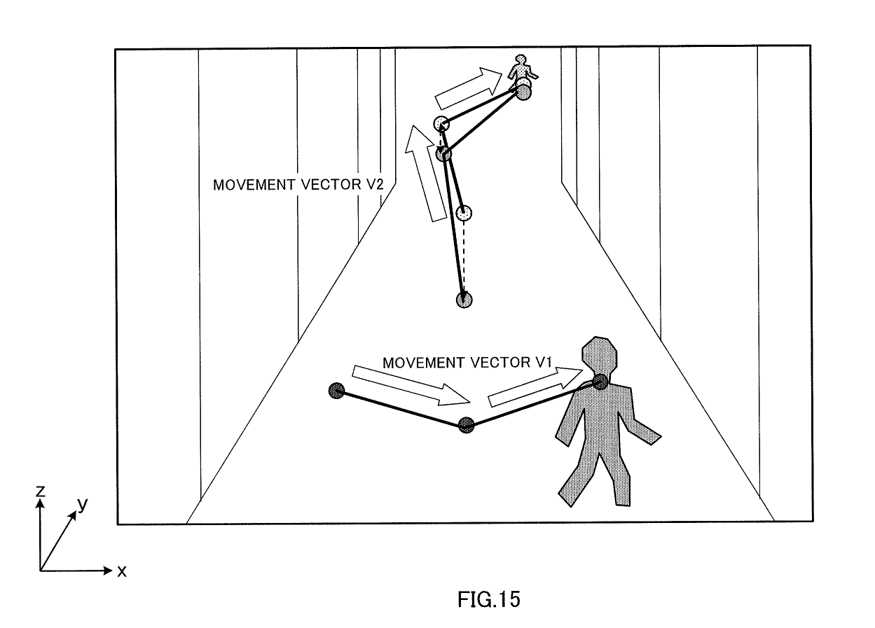

FIG. 14 shows the configuration of a three-dimensional motion locus display apparatus of this embodiment. Three-dimensional motion locus display apparatus 300 has imaging apparatus 310, position detection section 320, display motion locus generation apparatus 330, input apparatus 340, and display apparatus 350.

Imaging apparatus 310 is a video camera comprising a lens, imaging element, moving image encoding circuitry, and so forth. Imaging apparatus 310 may be a stereo video camera. There are no particular restrictions on the encoding method, and MPEG2, MPEG 4, MPEG4/AVC (H.264), or the like can be used, for example.

Position detection section 320 obtains positioning data of an object having three-dimensional information comprising a horizontal-direction component, depth-direction component, and height-direction component, by measuring by means of a radio wave a three-dimensional position of a wireless tag attached to the object. If imaging apparatus 310 is a stereo camera, position detection section 320 may measure a three-dimensional position of an object from stereoscopic parallax of captured images obtained by imaging apparatus 310. Position detection section 320 may also measure a three-dimensional position of an object using radar, infrared radiation, ultrasound, or the like. Essentially, position detection section 320 may be any kind of apparatus as long as it can obtain object positioning data having three-dimensional information comprising a horizontal-direction component, depth-direction component, and height-direction component.

Image receiving section 331 receives a captured image (moving image data) output from imaging apparatus 310 in real time, and outputs moving image data to image playback section 333 in accordance with a request from image playback section 333. Image receiving section 331 also outputs received moving image data to image storage section 332. If there is a restriction on the storage capacity of image storage section 332, for instance, image receiving section 331 may initially decode received moving image data, and output moving image data that has been re-encoded by means of an encoding method with higher compression efficiency to image storage section 332.

Image storage section 332 stores moving image data output from image receiving section 331, and also outputs moving image data to image playback section 333 in accordance with a request from image playback section 333.

Image playback section 333 decodes moving image data obtained from image receiving section 331 or image storage section 332 in accordance with a user command (not shown) from input apparatus 340 received via input receiving section 338, and outputs decoded moving image data to display apparatus 350.

Display apparatus 350 is a two-dimensional display that performs combined display of an image based on moving image data and a motion locus based on motion locus data obtained from motion locus generation section 337.

Position storage section 334 stores position detection results (positioning data) output from position detection section 320 as a position history. A time, an object ID, and position coordinates (x, y, z) are stored as one record. That is to say, position coordinates (x, y, z) of each time are stored in position storage section 334 for each object.

Imaging condition acquisition section 336 acquires imaging apparatus 310 PTZ (pan/tilt/zoom) information from imaging apparatus 310 as imaging condition information. If imaging apparatus 310 is movable, imaging condition acquisition section 336 receives changed imaging condition information each time imaging conditions change, and holds changed imaging condition information together with change time information as a history.

Position fluctuation determination section 335 is used when selecting whether or not a rounded motion locus is to be displayed according to an amount of fluctuation, as in (v) above. In response to an inquiry from motion locus generation section 337, position fluctuation determination section 335 extracts a plurality of records relating to the same ID within a fixed time from a position history stored in position storage section 334, calculates a height-direction (z-direction) component fluctuation range (difference between a maximum value and minimum value) in the screen, and determines whether or not the fluctuation range is greater than or equal to a threshold value. At this time, position fluctuation determination section 335 first converts position history coordinates (x, y, z) to a camera field-of-view coordinate system using imaging conditions (information relating to imaging apparatus 310 PTZ) acquired from imaging condition acquisition section 336, and then calculates an object's height-direction (z-direction) fluctuation range, and performs threshold value based determination for the calculation result. In the same way as when performing horizontal-direction (x-direction) determination, position fluctuation determination section 335 can calculate a horizontal-direction fluctuation range using a horizontal-direction (x-direction) coordinate converted to a camera field-of-view coordinate system, and perform threshold value based determination for the calculation result. It goes without saying that the above-described coordinate conversion is unnecessary if a coordinate system height-direction (z-direction) or horizontal-direction (x-direction) coordinate axis represented by a position detection section 320 positioning result matches a coordinate system height-direction or horizontal-direction coordinate axis in the camera field-of-view coordinate system.

Input apparatus 340 is an apparatus such as a mouse or suchlike pointing device, a keyboard, or the like, that inputs user operations.

Input receiving section 338 receives a user operation input signal from input apparatus 340, acquires user apparatus information such as a mouse (pointing device) position, drag amount, wheel rotation amount, or click event, a number of keyboard (arrow key) depressions, or the like, and outputs this information.

Motion locus generation section 337 receives an event corresponding to the start of motion locus generation (period specification information specifying a period for which motion locus display is to be performed from among past images, or a command event specifying that real-time motion locus display is to be performed, by means of a mouse click, menu selection, or the like) from input receiving section 338.

Motion locus generation processing by motion locus generation section 337 differs according to the motion locus display method, and therefore motion locus generation section 337 motion locus generation processing for each display method is described separately below. In this embodiment, a method whereby a rounded motion locus resulting from fixing a height-direction component of an object at a constant value is displayed, such as shown in FIG. 10, FIG. 12, and FIG. 13, and a method whereby a rounded motion locus resulting from fixing a horizontal-direction component of an object at a constant value is displayed, such as shown in FIG. 11, have been proposed, but in order to simplify the description, only processing that implements the method whereby a horizontal-direction component is fixed at a constant value is described below.

[1] When the display described in (v) above is performed (that is, when a rounded motion locus is generated only if an amount of fluctuation per unit time of a horizontal-direction component or height-direction component is greater than or equal to a threshold value)

In this case, motion locus generation processing is broadly divided into processing when a motion locus corresponding to a past image is displayed, and processing when a motion locus corresponding to a real-time image is displayed, and therefore these two cases are described separately below.
When a motion locus corresponding to a past image is displayed:

Motion locus generation section 337 issues an inquiry to position fluctuation determination section 335 as to whether or not a fluctuation range in period T specified by period specification information is greater than or equal to a reference value, and receives the determination result as input. If a determination result indicating that the fluctuation range is greater than or equal to the threshold value is input from position fluctuation determination section 335, motion locus generation section 337 converts position history data (x(t), y(t), z(t)) of period T read from position storage section 334 to motion locus coordinate data for displaying a rounded motion locus. On the other hand, if a determination result indicating that the fluctuation range is less than the threshold value is input from position fluctuation determination section 335, motion locus generation section 337 uses position history data (x(t), y(t), z(t)) of period T read from position storage section 334 directly as motion locus coordinate data.

That is to say, if it is determined by motion locus generation section 337 that a z-direction fluctuation range (height-direction fluctuation range) is greater than or equal to the threshold value, motion locus generation section 337 obtains motion locus coordinate data for displaying a rounded motion locus by converting coordinate data (x(t), y(t), z(t)) so that (x(t), y(t), z(t))→(x(t), y(t), A), and tεT, where A is a predetermined value. If A=0 is set at this time, rounded motion locus L1 fixed to the floor can be generated as shown in FIG. 10.

Lastly, motion locus generation section 337 generates motion locus data by connecting coordinate points indicated by the motion locus coordinate data, and outputs this to display apparatus 350. Motion locus generation section 337 may also generate motion locus data by performing curve interpolation of a polygonal line by means of spline interpolation or the like.
When a motion locus corresponding to a real-time image is displayed:

Motion locus generation section 337 reads the latest record for time T1 for which a command event has been received from the position storage section 334 position history, and starts motion locus generation. Provision may also be made for motion locus generation section 337 not to perform coordinate conversion processing according to a fluctuation range, but to generate motion loci sequentially in real time by issuing an inquiry to position fluctuation determination section 335 as to a fluctuation range for period T1 to R2 at point in time T2 after the elapse of a fixed period, and performing the same kind of processing as “when a motion locus corresponding to a past image is displayed” described above according to the determination result.

[2] When the display described in (vi) above is performed

Motion locus generation section 337 generates rounded motion locus data connecting coordinate points at which a horizontal-direction component (x-direction component) or height-direction component (z-direction component) is fixed at a constant value, original motion locus data connecting position history data coordinate points directly, and link segment data linking corresponding points on a rounded motion locus and original motion locus, and outputs these data to display apparatus 350.

Furthermore, motion locus generation section 337 varies the height of a rounded motion locus by varying the value of A in (x(t), y(t), z(t))→(x(t), y(t), A), tεT, in proportion to a degree of user operation, such as an amount of movement of a mouse wheel, acquired from input receiving section 338. By this means, the fluctuation range of the height of a rounded motion locus in the screen is greater toward the front (that is, toward the camera) and decreases progressively toward the rear (that is, farther away from the camera), so that an observer recognizing that a rounded motion locus is fixed in a plane can obtain a sense of pseudo-stereoscopic parallax (a sense of parallax increasing nearer the observer and decreasing as the distance from the observer increases), and can more accurately grasp the nature of a rounded motion locus extending in the depth direction.

Also, if motion loci of a plurality of objects are displayed at this time, a user may move the height of only the motion locus of an object specified using a GUI (Graphical User Interface) or the like. By this means, which motion locus is the motion locus of the specified object can be easily recognized.

As described above, according to this embodiment, by performing combined display of a rounded motion locus for which a predetermined coordinate component relating to positioning data of object OB1 is fixed at a constant value, and a captured image, motion loci can be presented in which height-direction (z-direction) movement of object OB1 and depth-direction (y-direction) movement of object OB1 are separated, enabling a user to distinguish between height-direction (z-direction) movement of object OB1 and depth-direction (y-direction) movement of object OB1 by means of rounded motion locus L1. By this means, according to this embodiment, three-dimensional motion locus display apparatus 300 can be implemented that enables an observer to easily grasp three-dimensional movement of an object, and enables visibility to be improved for an observer.

### Embodiment 4

In this embodiment, selection of whether or not the motion locus rounding processing described in Embodiment 3 is to be performed is based on the relationship between a line-of-sight vector of imaging apparatus (camera) 310 and a movement vector of object OB1.

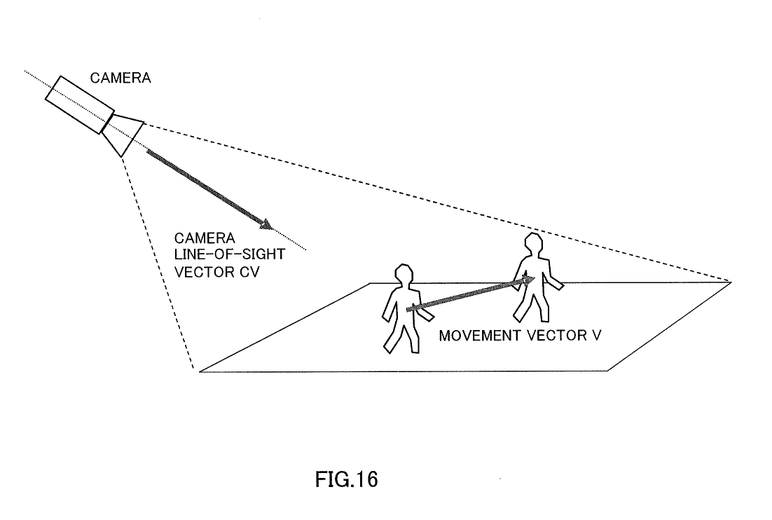

FIG. 15 is shows the nature of movement vectors V1 and V2 of object OB1 in a display image, and FIG. 16 is a drawing showing the relationship between movement vector V of object OB1 and line-of-sight vector CV of camera 310 in an imaging environment.

It is difficult to discern whether an original motion locus close to parallel to camera 310 line-of-sight vector CV is a movement in the depth direction (y direction) or a movement in the height direction (z direction). Focusing on this point, in this embodiment this kind of rounding processing described in Embodiment 3 is performed on an original motion locus close to parallel to line-of-sight vector CV.

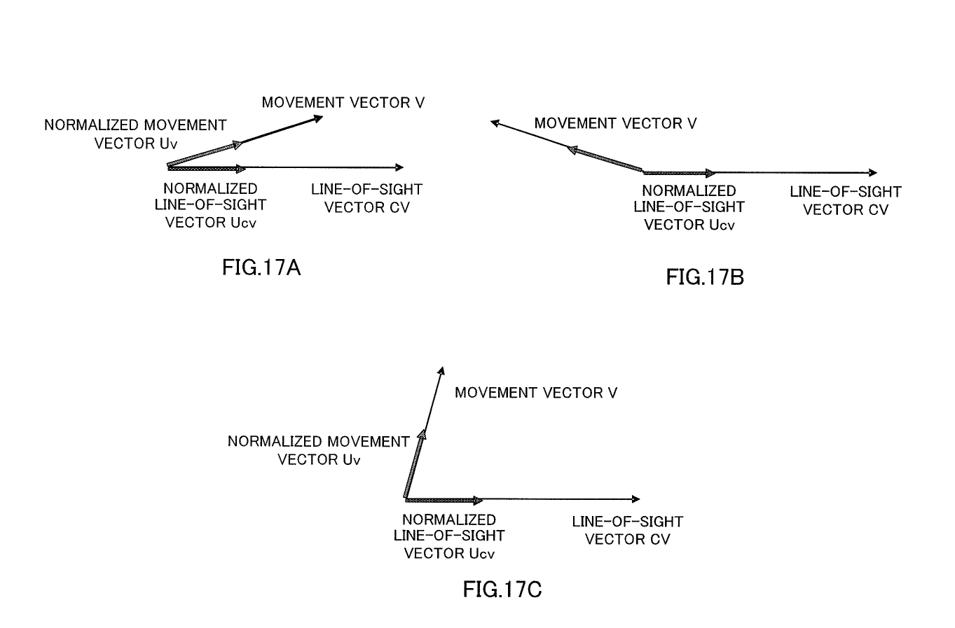

FIG. 17A and FIG. 17B show cases in which line-of-sight vector CV and object movement vector V are close to parallel, while FIG. 17C is a drawing showing a case in which line-of-sight vector CV and movement vector V are close to perpendicular.

If the absolute value of the inner product of vector Ucv resulting from normalizing line-of-sight vector CV and vector Uv resulting from normalizing movement vector V is greater than or equal to a predetermined value, line-of-sight vector CV and an original motion locus are determined to be close to parallel. A value such as 1/√2, for example, can be used as the predetermined value.

That is to say, when Ucv=CV/|CV| and Uv=V/|V|, if |Ucv·Uv|≧α (where α is a predetermined value), line-of-sight vector CV and an original motion locus are determined to be close to parallel, and a rounded motion locus is generated and displayed.

On the other hand, if the absolute value of the inner product of vector Ucv resulting from normalizing line-of-sight vector CV and vector Uv resulting from normalizing movement vector V is smaller than a predetermined value, line-of-sight vector CV and an original motion locus are determined to be close to perpendicular.

That is to say, when Ucv=CV/|CV| and Uv=V/|V|, if |Ucv·Uv|<α (where α is a predetermined value), line-of-sight vector CV and an original motion locus are determined to be close to perpendicular, rounding processing is not performed, and the original motion locus is generated and displayed.

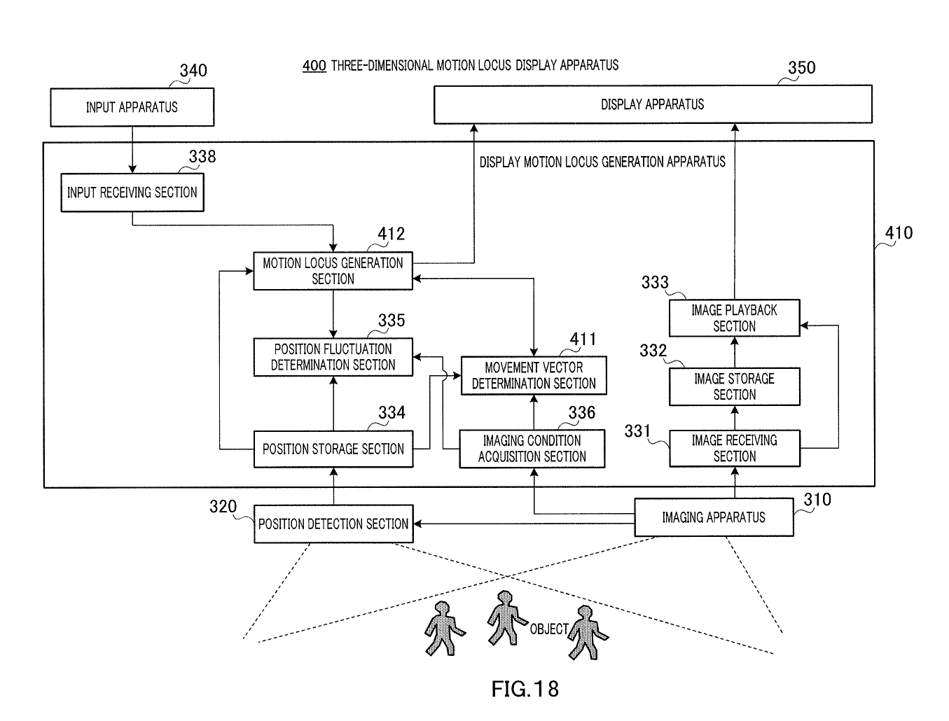

FIG. 18, in which parts corresponding to those in FIG. 14 are assigned the same reference codes as in FIG. 14, shows the configuration of a three-dimensional motion locus display apparatus of this embodiment. Display motion locus generation apparatus 410 of three-dimensional motion locus display apparatus 400 has movement vector determination section 411.

Movement vector determination section 411 receives an inquiry from motion locus generation section 412 (motion locus generation period information, or the like), and acquires imaging condition information (imaging apparatus 310 PTZ information) from imaging condition acquisition section 336 according to this inquiry. Movement vector determination section 411 calculates an imaging apparatus 310 line-of-sight vector (taking the vector magnitude as 1). Movement vector determination section 411 also acquires position history data for the relevant period from position storage section 334, and calculates a movement vector that is a vector between position coordinates (taking the vector magnitude as 1). As described above, movement vector determination section 411 performs threshold value based determination of the absolute value of the inner product of the line-of-sight vector and movement vector, and outputs the determination result to motion locus generation section 412.

If the absolute value of the inner product is greater than or equal to a threshold value, motion locus generation section 412 generates a rounded motion locus for which a height-direction component of position history data is fixed at a constant value, whereas if the absolute value of the inner product is less than the threshold value, motion locus generation section 412 does not perform rounding processing, and generates an original motion locus using position history data directly.

As described above, according to this embodiment, a motion locus for which rounding processing should be performed can be determined accurately.

In this embodiment, whether or not rounding processing is to be performed has been determined by performing threshold value based determination of the absolute value of the inner product of imaging apparatus 310 line-of-sight vector CV and object OB1 movement vector V, but whether or not rounding processing is to be performed may also be determined by performing threshold value based determination of the absolute value of the angle between a straight line parallel to line-of-sight vector CV and a straight line parallel to movement vector V. Specifically, if this angle is less than a threshold value, a rounded motion locus is generated for which a height-direction component in positioning data, or a height-direction component when direction components in positioning data are converted to the field-of-view coordinate system of imaging apparatus 310, is fixed at a constant value, whereas if the angle is greater than or equal to the threshold value, an original motion locus for which rounding processing is not performed is generated.

### Embodiment 5

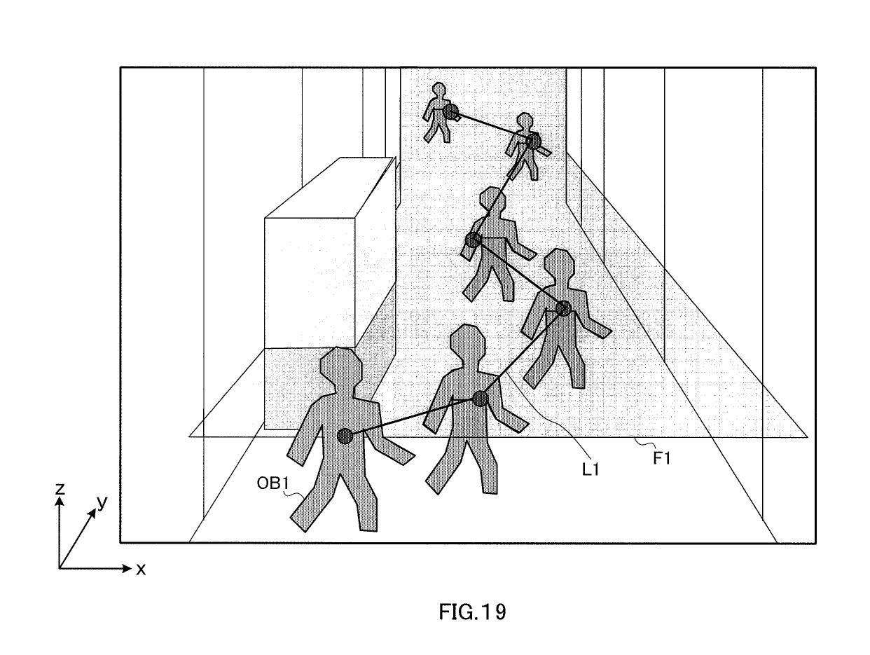

FIG. 19 shows an example of a display image proposed in this embodiment. In this embodiment, it is proposed that, in addition to generating and displaying a rounded motion locus for which a height-direction component (z-direction component) in positioning data is fixed at a constant value such as described in Embodiment 3, auxiliary plane F1 be generated and displayed at a height at which a rounded motion locus is present. As a result of explicitly indicating auxiliary plane F1 in which a rounded motion locus is present in this way, an observer can recognize that height-direction (z-direction) movement is fixed (pasted) onto auxiliary plane F1, and can sensorily discern that a rounded motion locus indicates only horizontal-direction (x-direction) and depth-direction (y-direction) movement.

If auxiliary plane F1 is made semi-transparent and hidden-surface processing is executed on an imaging object as shown in FIG. 19, a user can easily discern the relationship between an actual path of movement and a possible area of movement of object OB1 from the relationship between an imaging object and auxiliary plane F1.

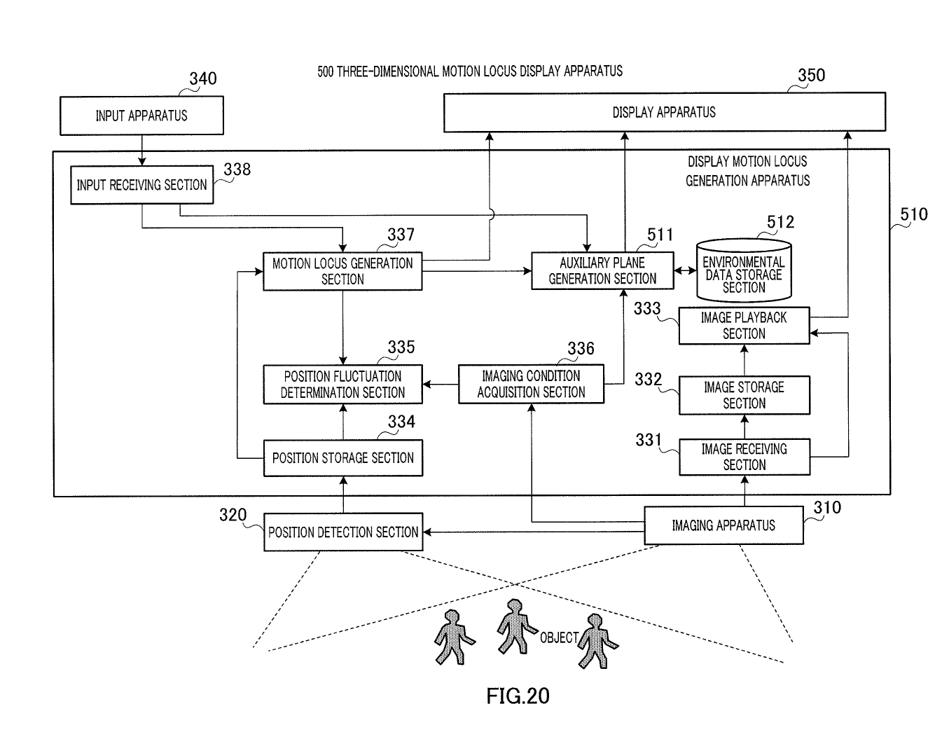

FIG. 20, in which parts corresponding to those in FIG. 14 are assigned the same reference codes as in FIG. 14, shows the configuration of a three-dimensional motion locus display apparatus of this embodiment. Display motion locus generation apparatus 510 of three-dimensional motion locus display apparatus 500 has auxiliary plane generation section 511 and environmental data storage section 512.

Auxiliary plane generation section 511 generates auxiliary plane F1 as a plane in which a rounded motion locus is present in accordance with rounded motion locus position information output from motion locus generation section 337. At this time, auxiliary plane generation section 511 issues an inquiry to environmental data storage section 512 and acquires three-dimensional position information relating to environmental objects (walls, pillars, furniture and fixtures, and so forth), and issues an inquiry to imaging condition acquisition section 336 and acquires imaging apparatus 310 PTZ information. Then auxiliary plane generation section 511 determines the anteroposterior relationship between auxiliary plane F1 and environmental objects, and performs auxiliary plane F1 hidden-surface processing.

Environmental data storage section 512 stores three-dimensional position information such as position information on walls, pillars, and suchlike architectural structures present within the object detection and imaging ranges of position detection section 320 and imaging apparatus 310, information on the layout of furniture and fixtures within these ranges, and so forth. Environmental data storage section 512 outputs this three-dimensional environmental information in response to an auxiliary plane generation section 511 inquiry.

### Embodiment 6

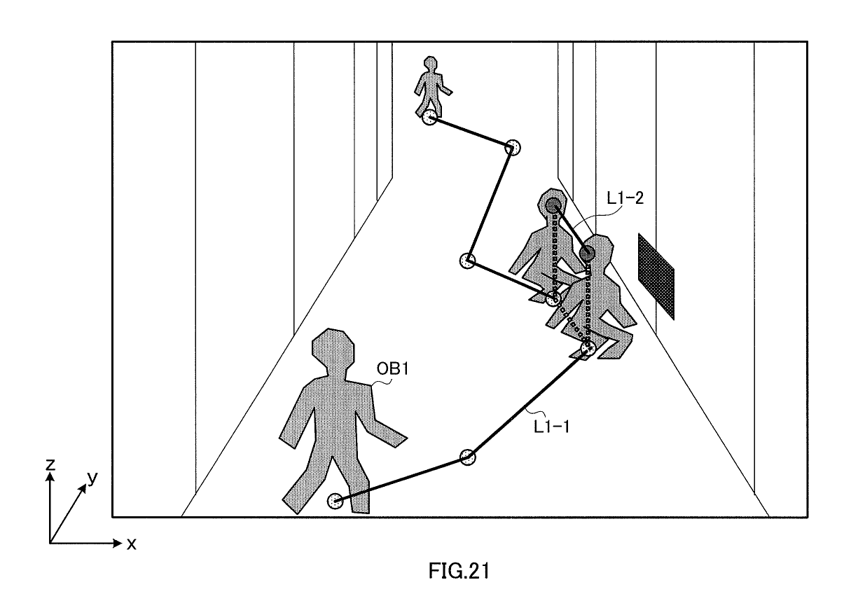

FIG. 21 shows an example of a display image proposed in this embodiment. In this embodiment, it is proposed that, in addition to generating and displaying rounded motion locus L1-1 for which a height-direction component (z-direction component) in positioning data is fixed at a constant value such as described in Embodiment 3, when object OB1 is a person, the height of rounded motion locus L1-2 of a section in which the head position of the person fluctuates greatly be made the actual head position height. Displaying such a rounded motion locus L1-2 enables a user to recognize a person's crouching action or the like, for example.

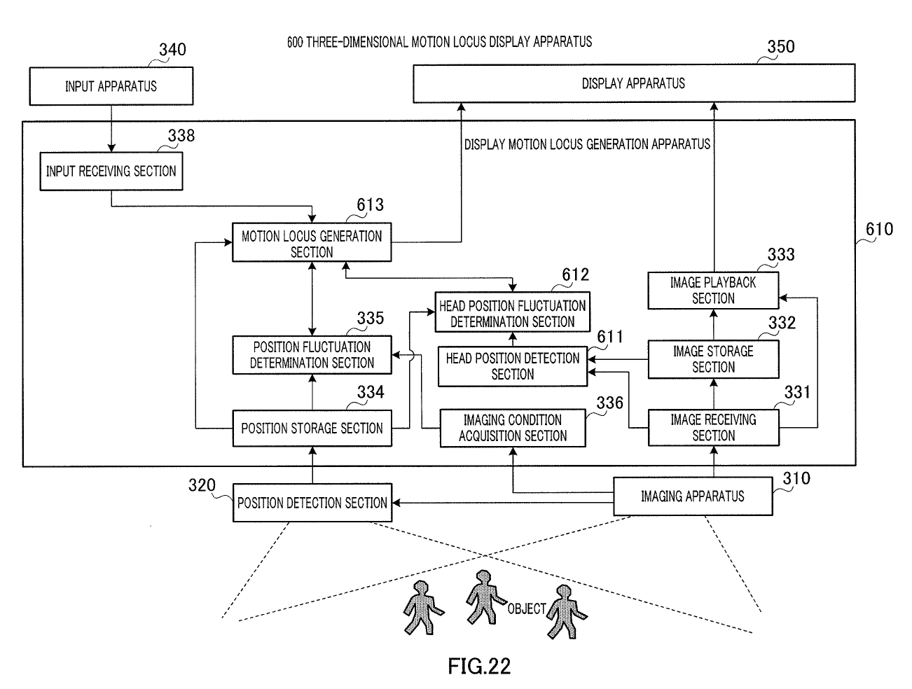

FIG. 22, in which parts corresponding to those in FIG. 14 are assigned the same reference codes as in FIG. 14, shows the configuration of a three-dimensional motion locus display apparatus of this embodiment. Display motion locus generation apparatus 610 of three-dimensional motion locus display apparatus 600 has head position detection section 611 and head position fluctuation determination section 612.

In response to an inquiry (specification period) from head position fluctuation determination section 612, head position detection section 611 acquires moving image data from image receiving section 331 or image storage section 332, detects a head position of an object when the object is a person by analyzing this data, and outputs the detection result to head position detection section 611. This head position detection can be implemented by means of known image recognition technology such as described in Non-Patent Literature 2, for example, and therefore a description thereof is omitted here.

In response to an inquiry (specification period) from motion locus generation section 613, head position fluctuation determination section 612 issues an inquiry to head position detection section 611 and acquires head positions for the relevant period, and calculates the fluctuation range of the head position z-coordinate (height direction in the screen). Specifically, the fluctuation range is calculated from the average height of the head position. Head position fluctuation determination section 612 determines whether or not the head position fluctuation range in the relevant period is greater than or equal to a predetermined threshold value, and outputs the determination result to motion locus generation section 613.

If a determination result indicating that the head position fluctuation range is greater than or equal to the threshold value is input from head position fluctuation determination section 612, motion locus generation section 613 converts period T position history data (x(t), y(t), z(t)) read from position storage section 334 so that, when the average head position for that period T is designated H, (x(t), y(t), z(t))→(x(t), y(t), H), and tεT. On the other hand, if a determination result indicating that the head position fluctuation range is less than the threshold value is input from head position fluctuation determination section 612, motion locus generation section 613 performs conversion so that (x(t), y(t), z(t))→(x(t), y(t), A), and tεT, where, for example, A is the floor height (A=0).

### Embodiment 7

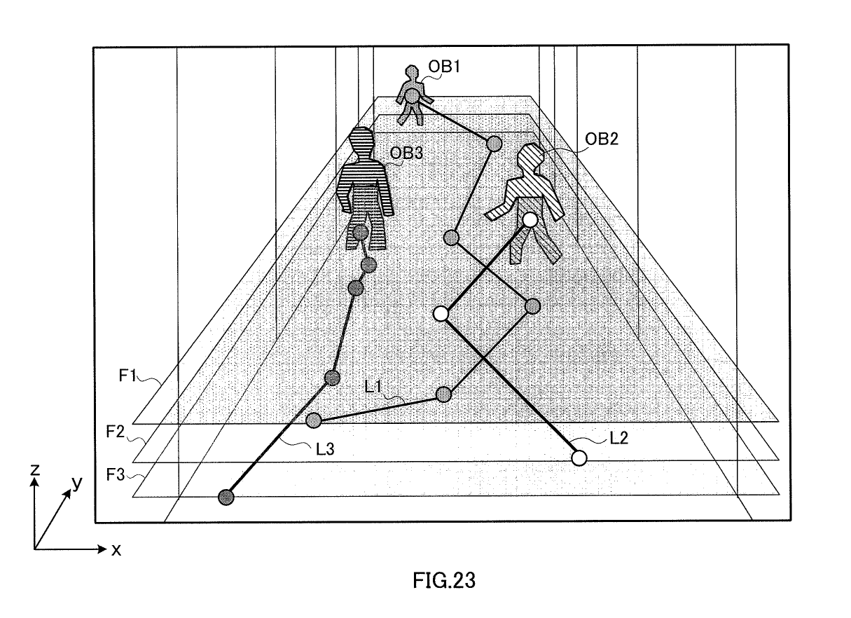

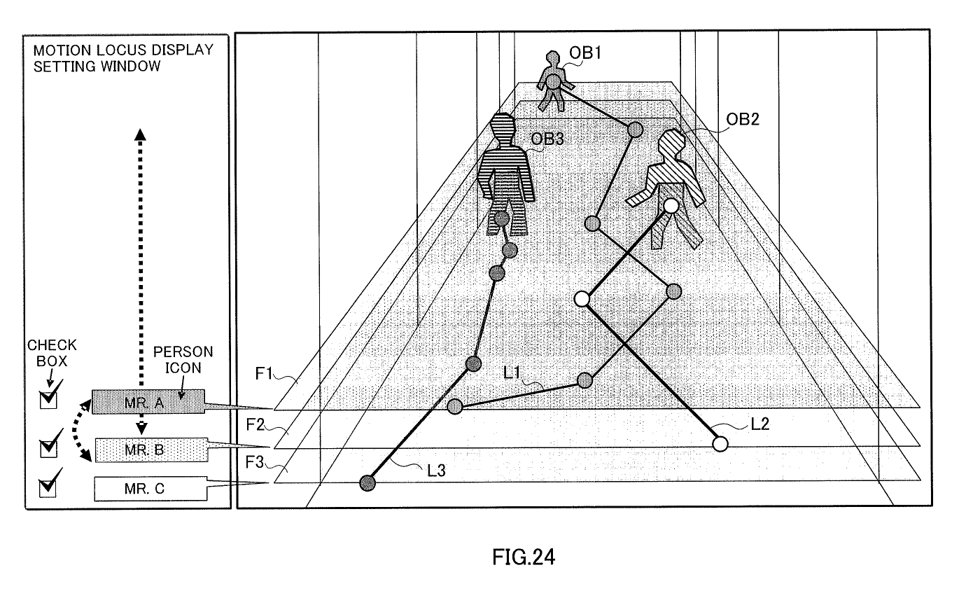

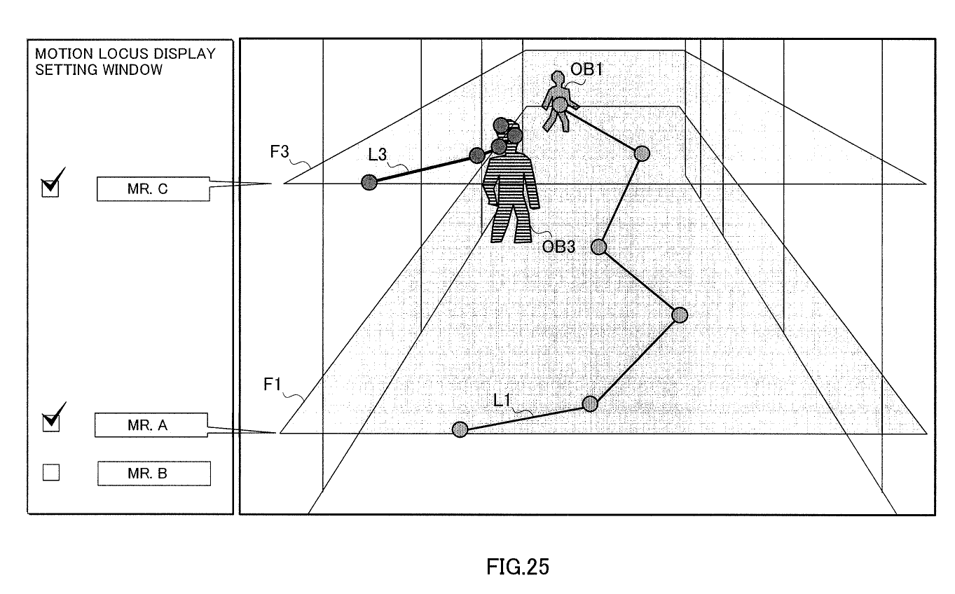

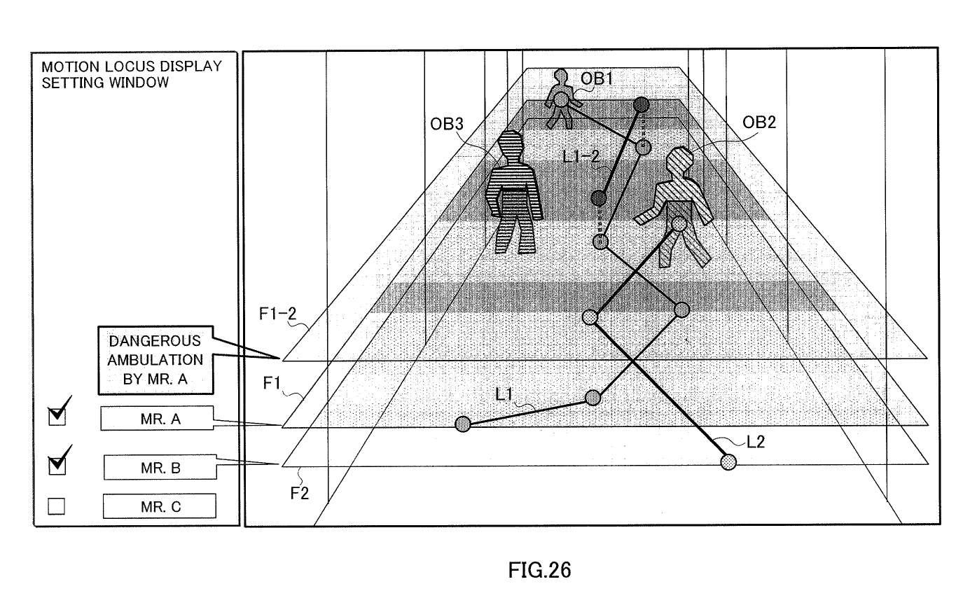

FIG. 23 through FIG. 26 show examples of display images proposed in this embodiment.
(i) FIG. 23 shows a display image in which rounded motion loci L1 through L3 are generated and displayed for which a height-direction (z-direction) constant value differs for each of objects OB1 through OB3. By this means, when rounded motion loci L1 through L3 of plurality of objects OB1 through OB3 are displayed simultaneously, rounded motion loci L1 through L3 can be displayed in a readily distinguishable and clearly visible manner. Furthermore, by generating and displaying semi-transparent auxiliary planes F1 through F3 such as described in Embodiment 5 at heights at which rounded motion loci L1 through L3 are present, rounded motion loci L1 through L3 are made still more readily distinguishable, and thus the movements of objects OB1 through OB3 become more clearly visible. A closely related plurality of persons may also be displayed on the same plane (at the same height). Also, heights may be set automatically according to the body heights of objects OB1 through OB3. Furthermore, when, for example, an object is mounted on a forklift in a factory, a rounded motion locus may be displayed at a correspondingly higher position.
(ii) FIG. 24 and FIG. 25 show display images in which, in addition to the display illustrated in FIG. 23, a GUI screen (the “motion locus display setting window” in the drawings) is displayed, and a user (observer) can make a constant value setting for each person by moving person icons in the GUI screen. By this means, height settings for rounded motion loci L1 through L3 can be coordinated with the person icons on the GUI, making intuitive operation and display possible. For example, when the height of a person icon is changed via the GUI, the height of a rounded motion locus and auxiliary plane corresponding to that person icon is also changed by the same amount as the height of the person icon. Also, if person icon heights are switched around via the GUI (for example, if the heights of a “Mr. B” person icon and a “Mr. A” person icon are switched around), rounded motion locus and auxiliary plane heights are also switched around accordingly. The height of a person icon corresponds to the height of a rounded motion locus and auxiliary plane. A display or non-display setting can be made for a rounded motion locus and auxiliary plane by means of a check box. FIG. 25 shows an example in which, as compared with the state shown in FIG. 24, non-display of rounded motion locus L2 and auxiliary plane F2 for “Mr. B” has been set, the heights of rounded motion loci L3 and L1 and auxiliary planes F3 and F1 for “Mr. C” and “Mr. A” have been switched around, and the height of rounded motion locus L3 and auxiliary plane F3 for “Mr. C” has been changed.
(iii) FIG. 26 shows a display screen in which, in addition to the display illustrated in FIG. 23, an abnormal- or dangerous-state section is highlighted. If a suspicious person, dangerous ambulatory state (such as running in an office), entry into a No Entry section, or the like, is detected based on image recognition, motion locus analysis, a sensing result of another sensor, or the like, highlighting the relevant section enables an observer (user) to be presented with a readily understandable warning. In the example in FIG. 26, dangerous ambulation by Mr. A is detected, and rounded motion locus L1-2 of the relevant section is highlighted by being displayed at a higher position that rounded motion locus L1 of other sections. In addition, auxiliary plane F1-2 is also newly displayed so as to correspond to highlighted rounded motion locus L1-2.

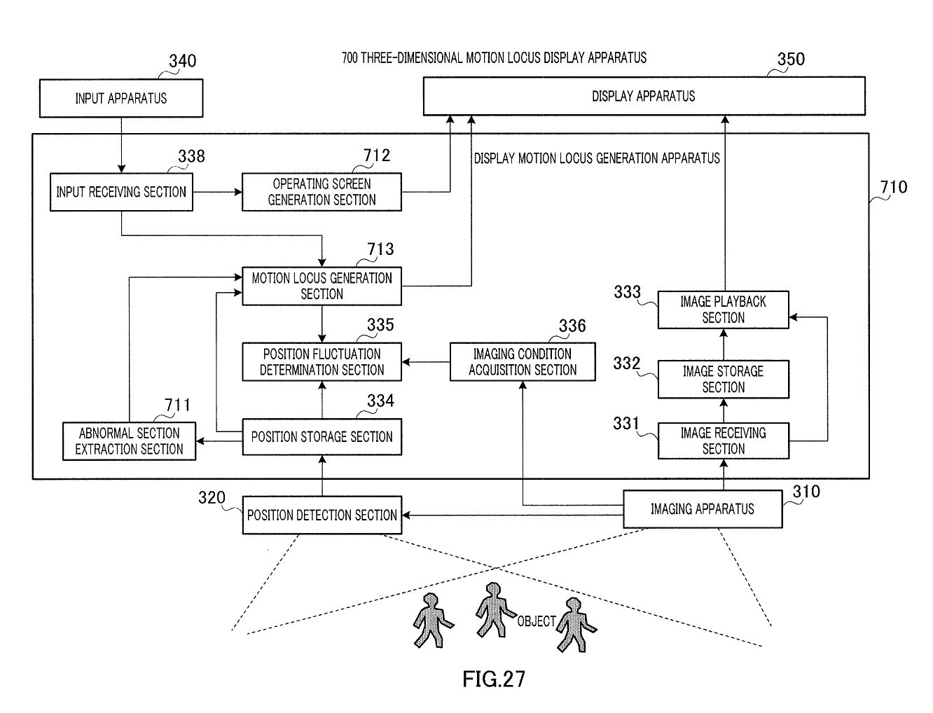

FIG. 27, in which parts corresponding to those in FIG. 14 are assigned the same reference codes as in FIG. 14, shows the configuration of a three-dimensional motion locus display apparatus of this embodiment. Display motion locus generation apparatus 710 of three-dimensional motion locus display apparatus 700 has abnormal section extraction section 711 and operating screen generation section 712.

Abnormal section extraction section 711 detects abnormal behavior of an object from a position history stored in position storage section 334, a captured image captured by imaging apparatus 310, or the like, extracts a position history record relating to the section in which abnormal behavior was detected, and outputs this record to motion locus generation section 713. Three examples of an abnormal section extraction method are given below, but abnormal section extraction methods are not limited to these.

(1) A standard motion locus of an object is set and held beforehand, and an abnormality is detected by comparison with the standard motion locus. (2) An Off Limits section to which entry by an object is prohibited is set and held beforehand, and whether or not an object has entered the Off Limits section is detected. (3) An abnormality is detected by performing image recognition using an image captured by imaging apparatus 310.

Operating screen generation section 712 generates an auxiliary operating screen that includes person icons for setting the heights of motion loci of each object (person) and check boxes for performing display/non-display switching. Operating screen generation section 712 generates an auxiliary operating screen in which a position of a person icon is moved and/or a check box on/off status is switched according to a mouse position, click event, mouse drag amount, or the like, output from input receiving section 338. Processing by this operating screen generation section 712 is similar to known GUI operating window generation processing.

### Embodiment 8

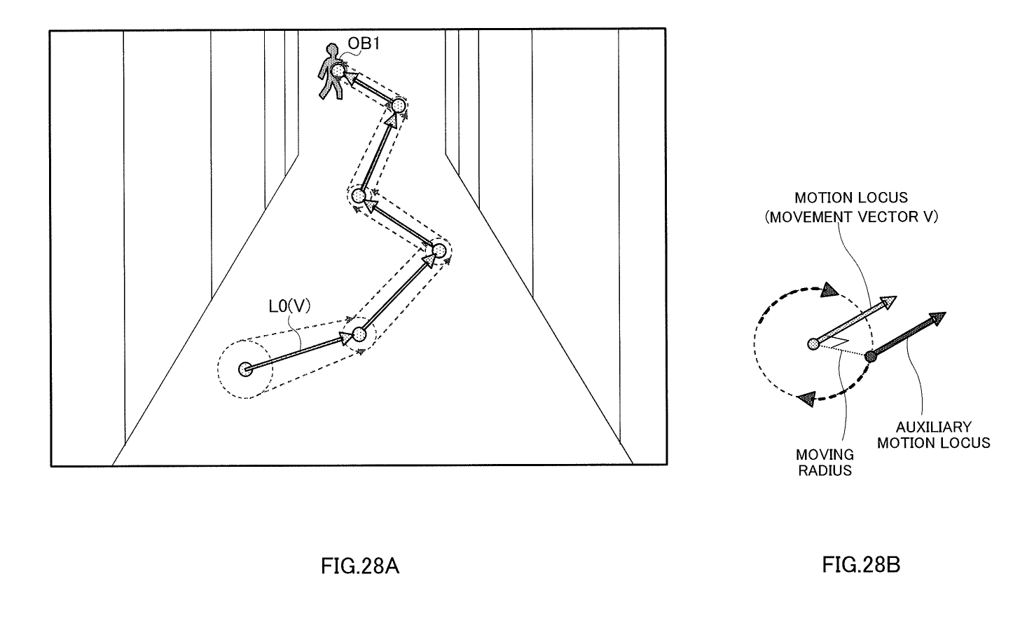

FIG. 28 shows an example of a display image proposed in this embodiment. In this embodiment, it is proposed that an auxiliary motion locus be displayed that performs a circular motion around original motion locus L0 with a moving radius perpendicular to movement vector V of object OB1. By this means, a motion locus can be presented that gives a pseudo-sense of depth without obscuring a captured image.

According to the method proposed in this embodiment, a motion locus can be presented that gives a pseudo-sense of depth without obscuring a captured image, even if a rounded motion locus is not used. That is to say, it is sufficient to generate original motion locus L0 and an auxiliary motion locus that performs a circular motion around original motion locus L0 with a moving radius perpendicular to object movement vector V, and to display these. Provision may also be made for a rounded motion locus and an auxiliary motion locus that performs a circular motion around the rounded motion locus with a moving radius perpendicular to object movement vector V to be generated, and for these to be displayed.

Such an auxiliary motion locus can be displayed by generating an auxiliary motion locus that performs a circular motion with a moving radius perpendicular to a movement vector (a vector from a certain motion locus coordinate point toward the next motion locus coordinate point) when motion locus data is generated by motion locus generation section 337, 412, 613, or 713, outputting this auxiliary motion locus to display apparatus 350. If motion locus interpolation is performed by means of a spline curve or the like, an auxiliary motion locus may be made a spline curve that performs a circular motion with a moving radius perpendicular to a spline curve after interpolation.

### Other Embodiments

In above Embodiments 1 and 2, cases have been described in which coordinate data from a wireless tag is acquired using tag reader sections 102 and 202 respectively, but the present invention is not limited to this, and various positioning means capable of positioning an object to be tracked can be applied instead of tag reader section 102/202. Possible positioning means for replacing tag reader section 102/202 include radar, an ultrasound sensor, a camera, or the like, provided in a position allowing an object to be tracked to be positioned when an object to be tracked enters a concealed position as viewed from camera section 101/201. Also, in an indoor situation, an object to be tracked may be positioned by providing numerous sensors on the floor. The essential point is that, when an object to be tracked enters a concealed position as viewed from camera section 101/201, the positioning means should be able to pinpoint that position.

Also, in above Embodiments 1 and 2, cases have been described in which camera sections 101 and 201 have image tracking section 101-2 and imaging coordinate acquisition section 201-2 respectively, and motion locus type selection sections 105 and 205 determines a motion locus display type based on tracking status data (a detection flag) and imaging coordinate data obtained by image tracking section 101-2 and imaging coordinate acquisition section 201-2 respectively, but the present invention is not limited to this, the essential point being that the display type of a motion locus corresponding to each point in time should be selected according to whether or not an object to be tracked is shown in a captured image at each point in time.

Furthermore, in above Embodiments 1 and 2, cases have been described in which “solid line” is selected as a motion locus type when an object to be tracked is determined not to be in a concealed position, and “dotted line” is selected as a motion locus type when an object to be tracked is determined to be in a concealed position, but the present invention is not limited to this, and provision may also be made, for example, for a “thick line” to be selected as a motion locus type when an object to be tracked is determined not to be in a concealed position, and for a “thin line” to be selected as a motion locus type when an object to be tracked is determined to be in a concealed position. Alternatively, the color of a motion locus may be changed according to whether an object to be tracked is determined not to be in a concealed position or is determined to be in a concealed position. The essential point is that different motion locus display types should be selected when an object to be tracked is not in a concealed position, and when an object to be tracked is in a concealed position, as viewed from the camera section.

A motion locus display type may also be changed according to the status of a wireless tag. For example, if the color of a motion locus is changed when information indicating a low battery level is received from a wireless tag, a user can learn that the battery level is low from the motion locus color, and can take this as a guideline for a battery change.

It is possible for image tracking section 101-2, imaging coordinate acquisition section 201-2, motion locus type selection sections 105 and 205, and motion locus creation sections 106 and 206, used in Embodiments 1 and 2 respectively, to be implemented by means of a general-purpose computer such as a personal computer, with the processing included in image tracking section 101-2, imaging coordinate acquisition section 201-2, motion locus type selection section 105/205, and motion locus creation section 106/206 being implemented by reading software programs corresponding to the processing of each processing section stored in computer memory, and having these programs executed by a CPU.

Similarly, it is possible for display motion locus generation apparatuses 330, 410, 510, 610, and 710 used in Embodiments 3 through 8 respectively to be implemented by means of a general-purpose computer such as a personal computer, with the processing included in motion locus generation apparatuses 330, 410, 510, 610, and 710 being implemented by reading software programs corresponding to the processing of each processing section stored in computer memory, and having these programs executed by a CPU. Motion locus generation apparatuses 330, 410, 510, 610, and 710 may also be implemented by means of a dedicated device incorporating LSI chips corresponding to each processing section.

The disclosures of Japanese Patent Application No. 2008-268687, filed on Oct. 17, 2008, and Japanese Patent Application No. 2009-018740, filed on Jan. 29, 2009, including the specifications, drawings and abstracts, are incorporated herein by reference in their entirety.

### INDUSTRIAL APPLICABILITY

The present invention is suitable for use in a system that displays a path of movement of a person or object by means of a motion locus, such as a surveillance system, for example.

1-32. (canceled)

33. A motion locus creation system comprising:
an imaging section that obtains a captured image of an area including an object to be tracked;
a positioning section that positions said object to be tracked and outputs positioning data of said object to be tracked;
a motion locus type selection section that selects a display type of a motion locus corresponding to each point in time according to whether or not said object to be tracked is shown in said captured image of said each point in time;
a motion locus creation section that forms motion locus data based on said positioning data and a motion locus display type selected by said motion locus type selection section; and
a display section that displays an image based on said captured image and a motion locus based on said motion locus data in an overlapping manner.

34. The motion locus creation system according to claim 33, wherein said positioning section obtains said positioning data based on a radio signal received from a wireless tag attached to said object to be tracked.

35. The motion locus creation system according to claim 33, wherein:
said imaging section has an image capturing section that obtains a captured image, and an image tracking section that obtains tracking status data indicating whether or not said object to be tracked is shown in a captured image of said each point in time; and
said motion locus type selection section selects a display type of a motion locus based on said tracking status data.

36. The motion locus creation system according to claim 33, wherein:
said imaging section has an image capturing section that obtains a captured image, and an imaging coordinate acquisition section that obtains imaging coordinate data of said object to be tracked in a captured image of said each point in time; and
said motion locus type selection section selects a display type of a motion locus based on presence or absence of said imaging coordinate data in a captured image of said each point in time.

37. The motion locus creation system according to claim 33, wherein said motion locus type selection section selects a solid line when said object to be tracked is shown in said captured image, and selects a dotted line when said object to be tracked is not shown in said captured image.

38. The motion locus creation system according to claim 33, wherein said motion locus type selection section determines that said object to be tracked is not shown in said captured image only when captured images in which said object to be tracked is not shown continue for at least threshold value th (where th≧2).

39. The motion locus creation system according to claim 33, wherein said motion locus type selection section determines that said object to be tracked is not shown in said captured image only when a ratio of a number of captured images in which said object to be tracked is not shown, to a total number of a temporally consecutive plurality of captured images, is greater than or equal to a threshold value.

40. A motion locus creation apparatus comprising:
a motion locus type selection section that selects a display type of a motion locus corresponding to each point in time according to whether or not an object to be tracked is shown in a captured image of said each point in time; and
a motion locus creation section that forms motion locus data based on positioning data of said object to be tracked and a motion locus display type selected by said motion locus type selection section.

41. The motion locus creation apparatus according to claim 40, wherein said motion locus type selection section selects a solid line when said object to be tracked is shown in said captured image, and selects a dotted line when said object to be tracked is not shown in said captured image.

42. The motion locus creation apparatus according to claim 40, wherein said motion locus type selection section determines that said object to be tracked is not shown in said captured image only when captured images in which said object to be tracked is not shown continue for at least threshold value th (where th≧2).

43. The motion locus creation apparatus according to claim 40, wherein said motion locus type selection section determines that said object to be tracked is not shown in said captured image only when a ratio of a number of captured images in which said object to be tracked is not shown, to a total number of temporally consecutive plurality of captured images, is greater than or equal to a threshold value.

44. A motion locus creation method comprising:
a step of forming a motion locus that is a path of movement of an object to be tracked utilizing positioning data of said object to be tracked of each point in time; and
a step of selecting a type of said motion locus on a segment-by-segment basis according to whether or not said object to be tracked is shown in a captured image of said each point in time.
